(19) United States
(12) Patent Application Publication
(10) Pub. No.: US 2015/0160834 A1
(43) Pub. Date: Jun. 11, 2015

(54) PORTABLE APPARATUS AND METHOD FOR DISPLAYING A SCREEN THEREOF

(71) Applicant: SAMSUNG ELECTRONICS CO., LTD., Suwon-si (KR)

(72) Inventors: Jang-woo LEE, Seoul (KR); Jung-kun LEE, Seoul (KR); Jong-woo JUNG, Hwaseong-si (KR); Ye-seul HONG, Seoul (KR)

(73) Assignee: SAMSUNG ELECTRONICS CO., LTD., Suwon-si (KR)

(21) Appl. No.: 14/502,215

(22) Filed: Sep. 30, 2014

(30) Foreign Application Priority Data
Dec. 5, 2013 (KR) 10-2013-0150858

(51) Int. Cl. G06F 3/0484; G06F 3/0481

(52) U.S. Cl. CPC G06F 3/04842; G06F 3/04817

(57) ABSTRACT

A portable apparatus and a method for displaying a screen of the portable apparatus are provided. A method for displaying a screen of a portable apparatus includes detecting a touch on an icon corresponding to a timeline application displayed on a touch screen; and displaying a screen of the timeline application including a timeline area in which a timeline including a plurality of event times is displayed and an event area in which a plurality of event information corresponding to the plurality of event times is displayed. The plurality of event times are disposed apart from one another at an interval corresponding to a time gap therebetween in the timeline.

### CROSS-REFERENCE TO RELATED APPLICATION

This application claims priority from Korean Patent Application No. 10-2013-0150858, filed on Dec. 5, 2013, in the Korean Intellectual Property Office, the disclosure of which is incorporated herein by reference in its entirety.

### BACKGROUND

1. Field

Apparatuses and methods consistent with exemplary embodiments relate to a portable apparatus and a method for displaying a screen thereof, and more particularly, to a portable apparatus which displays an application screen that includes a timeline area, which includes a timeline where event time is displayed, and an event area, and a method for controlling a screen of the portable apparatus.

2. Description of the Related Art

A portable apparatus provides diversified services and functions. Thus, various applications executable at a portable apparatus are provided. In a time-related application, contents are arranged in an interval of preset or prestored time period.

When a plurality of contents are displayed, a part of content information may not be displayed on a screen, and thus, a user may not intuitively recognize information of each content.

### SUMMARY

According to an aspect of an exemplary embodiment, there is provided a method for displaying a screen of a portable apparatus, the method including: detecting a touch from an icon corresponding to a timeline application displayed on a touch screen, and displaying a screen of the timeline application which includes a timeline area in which a timeline including a plurality of event times is displayed and an event area in which a plurality of event information corresponding to the plurality of event times is displayed, wherein the plurality of event times are disposed apart from one another at an interval corresponding to a time gap therebetween in the timeline.

The timeline application may include an alarm application, and the displaying may include displaying a present time on the timeline area.

The timeline may display a present time as a starting position of the timeline and the plurality of event times may be disposed on the timeline according to a time gap from the present time.

The displaying may include displaying additional information including weather information corresponding to at least one of the plurality of event times.

The method may further include detecting a direction in which the portable apparatus is positioned, wherein the displaying may include displaying the timeline area on at least one from among an upper side, a lower side, a left side, and a right side of the event area, according to the detected direction of the portable apparatus.

The method may further include, in response to selecting event information at the event area, changing a position of an event time, which is displayed on the timeline, corresponding to the selected event information.

The method may further include, in response to selecting an event time at the timeline area, changing a position of event information, which is displayed on the event area, corresponding to the selected event time.

The method may further include, based on the changed position of the event information corresponding to the selected event time, displaying on the event area the event information and next event information, the next event information corresponding to an event time subsequent to the selected event time in a temporal order.

The timeline application may include a call application, the application screen may further include a call screen area, and the plurality of event information may include an outgoing call, an incoming call, or an missed call.

The timeline area may be displayed on at least one of a right side and a left side of the event area.

The displaying may include displaying, at the timeline area, at least one from among a past call start time, a past call duration time, and a time gap between the past call start time and a present time.

The method may further include, in response to a first touch gesture detected from event information of the event area, expanding the timeline area which corresponds to the event information.

The method may further include, in response to a second touch gesture detected from one event information of the event area, deleting the event information.

The displaying may include displaying, on the timeline area, at least one missed call and the number of the at least one missed call.

According to an aspect of an exemplary embodiment, there is provided a portable apparatus including: a touch screen configured to display an icon corresponding to a timeline application and a controller configured to control the touch screen, wherein the controller, in response to a touch on the icon, displays a screen of the timeline application including a timeline area in which a timeline including a plurality of event times is displayed and an event area in which a plurality of event information corresponding to the plurality of event times is displayed, wherein the plurality of event times are disposed apart from one another at an interval corresponding to a time gap therebetween in the timeline.

The apparatus may further include a sensor configured to detect a direction in which the portable apparatus is positioned, wherein the controller may control the touch screen to display the timeline area on at least one from among an upper side, a lower side, a let side, and a right side of the event area, according to the detected direction.

The controller, in response to selecting event information at the event area, may control to change a position of an event time, which is displayed on the timeline, corresponding to the selected event information, and update additional information which is displayed corresponding to the event time.

The controller, in response to selecting an event time at the timeline area, may change a position of event information, which is displayed on the event area, corresponding to the selected event time, and may display on the event area the event information and next event information, the next event information corresponding to an event time subsequent to the selected event time in a temporal order.

The application screen may further include a call screen area, and wherein the controller may control to display the timeline area on at least one of a right side and a left side of the event area.

The controller may control to display each of the plurality of event times, on the timeline, according to a time gap between the each of the plurality of event times and the present time as a starting position of the timeline.

### BRIEF DESCRIPTION OF THE DRAWINGS

The above and/or other aspects will be more apparent by describing certain exemplary embodiments with reference to the accompanying drawings, in which:

FIG. 1 is a front perspective view illustrating a portable apparatus according to an exemplary embodiment;

FIG. 2 is a rear perspective view illustrating a portable apparatus according to an exemplary embodiment;

FIG. 3 is a block diagram illustrating a portable apparatus according to an exemplary embodiment;

FIG. 4 is a flowchart illustrating a method for controlling brightness of a screen of a portable apparatus according to an exemplary embodiment;

FIGS. 5A to 5G are views illustrating a method for displaying a screen of a portable apparatus according to exemplary embodiments;

FIGS. 6A and 6B are views illustrating an event time interval of a timeline area according to an exemplary embodiment;

FIG. 7 is a flowchart illustrating a method for displaying a screen of a portable apparatus according to another exemplary embodiment;

FIGS. 8A to 8G are views illustrating a method for displaying a screen of a portable apparatus according to another exemplary embodiments; and

FIG. 9 is a view illustrating an event time interval of a timeline area according to another exemplary embodiment.

### DETAILED DESCRIPTION

Certain exemplary embodiments are described in detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments may be practiced without those specifically defined matters. Also, well-known functions or constructions are not described in detail because they would obscure exemplary embodiments with unnecessary detail.

Terms including an ordinal number such as “the first” and “the second” may be used to explain various elements, but the elements are not limited by these terms. The terms are used to distinguish one element from another element. For example, the first element may be named as the second element, and similarly, the second element may be named as the first element. The term “and/or” includes a combination of a plurality of elements or one of the plurality of elements.

An application indicates a software executed on a computer operating system (OS) or a mobile OS and used by a user. Examples are a word processor, a spread sheet, a social networking service (SNS), chatting, a map, a music player, and a video player, or the like. An application according to an exemplary embodiment indicates a software which is usable by a user by using an inputter.

A widget indicates a mini application which is one of graphic user interfaces (GUIs) that further facilitates interactions between a user and an application or an user and an OS. Examples are a weather widget, a calculator widget, a clock widget, or the like. A widget may be a shortcut icon format and be installed at a desk top, a portable apparatus, blog, internet café, a personal website, or the like. Through a widget, services may be used by click without using a web browser. Further, a widget may include a short cut to a designated path or a shortcut icon which may execute a designated application. A widget according to an exemplary embodiment means a mini application usable by a user using an inputter.

The terms used herein are provided to describe particular embodiments only, and are not intended to limit and/or exemplary embodiments. A singular expression, unless the context clearly used otherwise, includes plural meaning. In the present application, the term “including” or “having” are intended to specify the features, numbers, steps, operations, elements, components, or combinations thereof which are listed in the specification, and one or more other features should be understood that they do not preclude the features, numbers, steps, operations, elements, components, or combinations thereof, or the presence of additional possibilities. For the reference numeral on each drawing indicates the component which performs substantially the same function.

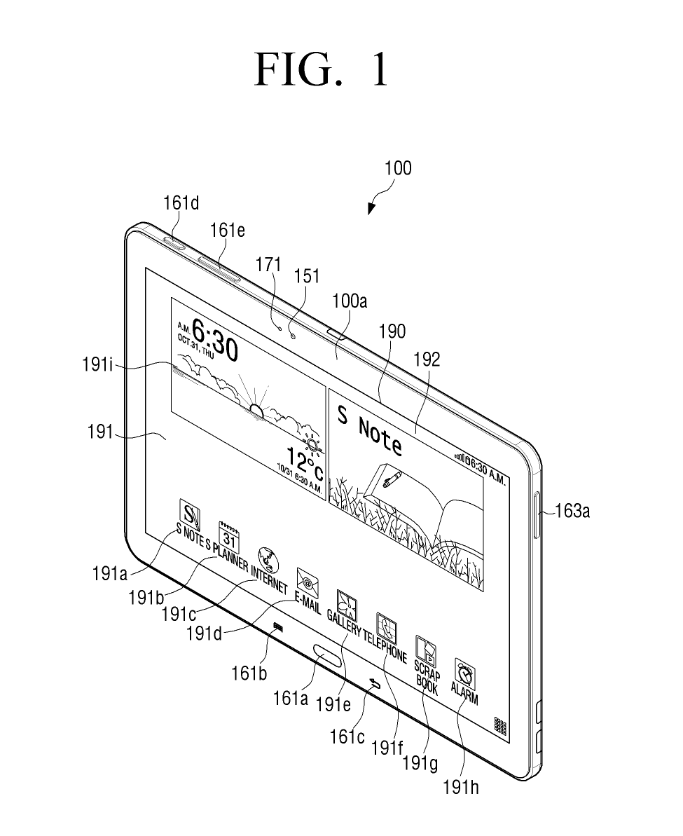

FIG. 1 is a front perspective view illustrating a portable apparatus according to an exemplary embodiment.

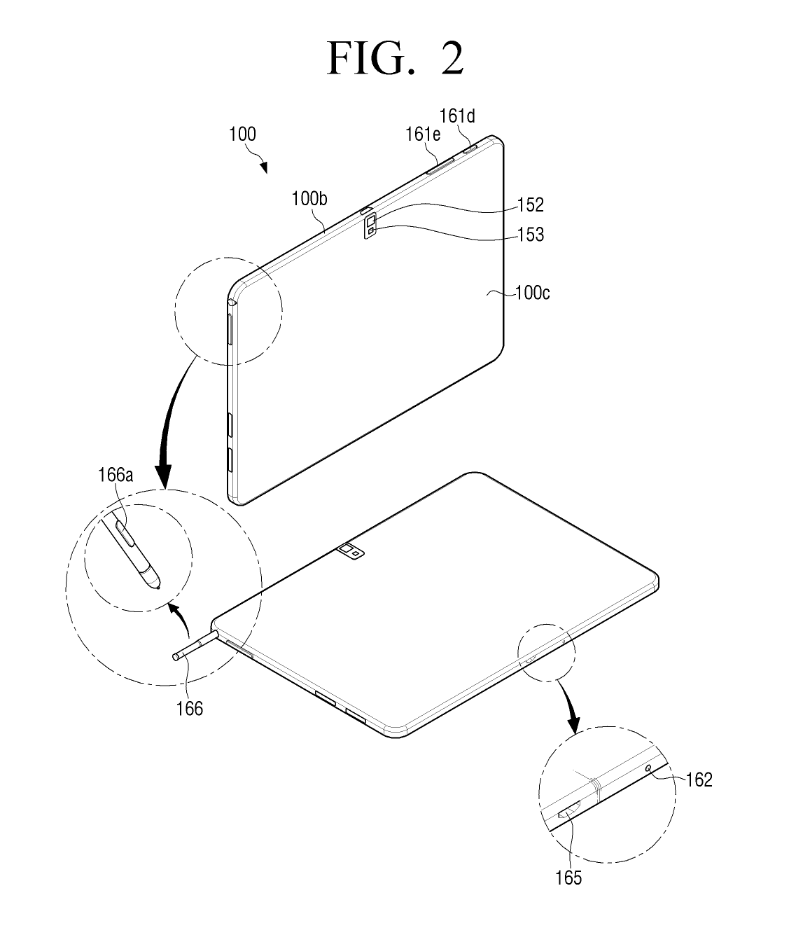

FIG. 2 is a rear perspective view illustrating a portable apparatus according to an exemplary embodiment.

Referring to FIG. 1, on a front side 100a of a portable apparatus 100, a touch screen 190 is located. FIG. 1 illustrates an example where a home screen 191 is displayed on the touch screen 190 of the portable apparatus 100. The portable apparatus 100 may have a plurality of home screens different from each other. In the home screen 191, a plurality of shortcut icons 191a-191h which correspond to a plurality of applications selectable by touch and a weather or clock widget 191i may be displayed. In an upper part of the home screen 191, a status bar 192 which displays a state of the portable apparatus 100 such as a charging state, strength of a received signal, and a current time may be displayed. The home screen 191 of the portable apparatus 100 may be located below the status bar 192. Further, in an alternative embodiment, the portable apparatus 100 may display the home screen 191 without the status bar 192.

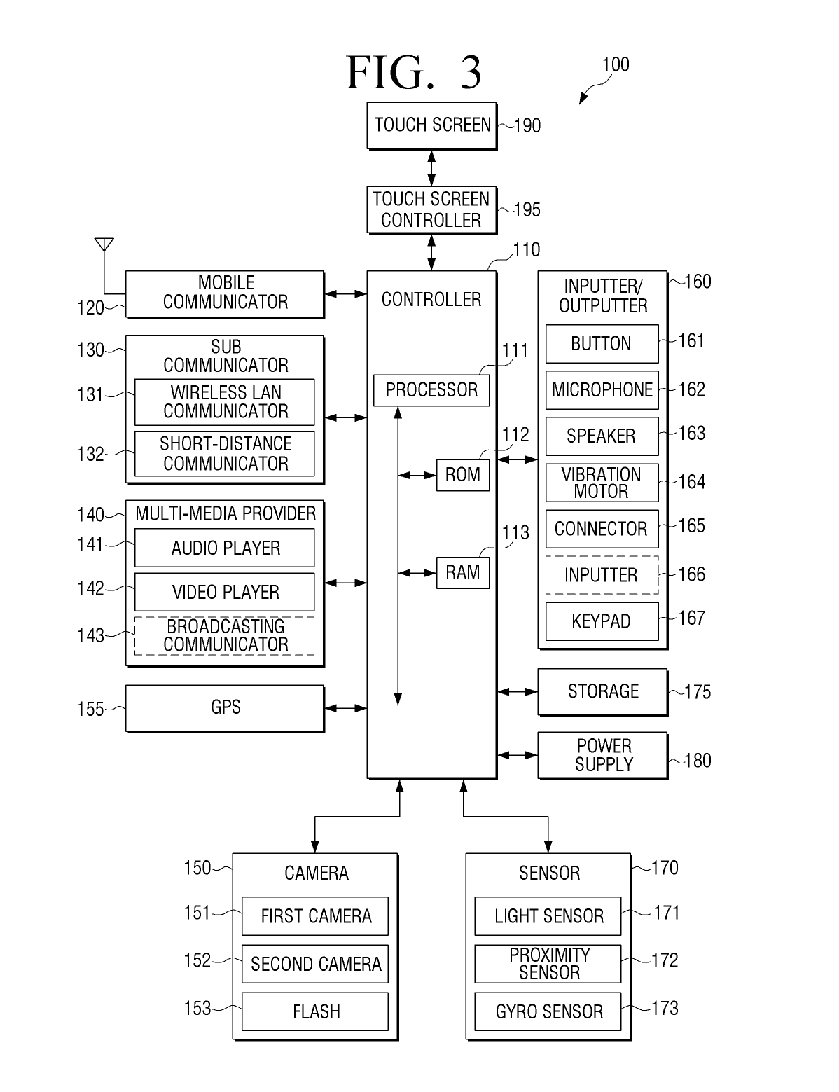

In an upper part of the front side 100a of the portable apparatus 100, a first camera 151, and a light sensor 171 may be provided. Also, although not shown in FIG. 1, a proximity sensor 172 (refer to FIG. 3) may be located on a side of the portable apparatus 100. In a lateral side of the portable apparatus 100, a speaker 163a may be provided. The speaker 163a may include a plurality of speakers. Referring to FIG. 2, on a rear side 100c of the portable apparatus 100, a second camera 152 and a flash 153 may be located.

In a lower part of the front side 100a of the portable apparatus 100, a home button 161a, a menu button 161b, and a back button 161c are located. The buttons 161a-161c may be implemented as a physical button or a touch button. Further, when implemented as a touch button, one of the buttons 161a-161c may be displayed along with a text within the touch screen 190 or other icons.

On an upper side 100b of the portable apparatus 100, a power/lock button 161d, and a volume button 161e may be located. On a bottom side of the portable apparatus 100, a connector 165 which may be connected with an external apparatus by wire and one or a plurality of microphones 162 may be located. In addition, on the lateral side of the portable apparatus 100, an insertion hole into which an inputter 166 having a button 166a may be inserted may be provided. The inputter 166 may be stored inside the portable apparatus 100 through the insertion hole, and may be withdrawn from the insertion hole of the portable apparatus 100 to be used. In the above, examples of a plurality of components of the portable apparatus 100 and position thereof are described. However, it should be noted that this is only an example and exemplary embodiments are not limited thereto.

FIG. 3 is a block diagram illustrating a portable apparatus according to an exemplary embodiment.

In FIG. 3, the portable apparatus 100 may be connected with an external apparatus (not illustrated) by wire or wirelessly using at least one from among a mobile communicator 120, a sub communicator 130, and the connector 165. The external apparatus may include another portable apparatus such as a mobile phone, a smartphone, and a tablet personal computer (PC), an electronic board such as an interactive white board, and a server.

The portable apparatus 100 may transceive data through an inputter such as a touch screen and a communicator. inputter The portable apparatus 100 may have one or more touch screens. The portable apparatus, for example, may include an MP3 player, a video player, a tablet PC, a three dimensional television (3D TV), a smart TV, a light emitting diode (LED) TV, a liquid crystal display (LCD) TV, or the like. The portable apparatus 100 may include an apparatus which may transceive data using a connectable external apparatus and interactions such as, for example, a touch or a touch gesture input through an inputter (e.g., a touch screen).

The portable apparatus 100 includes the touch screen 190 and a touch screen controller 195. The portable apparatus 100 includes a controller 110, a mobile communicator 120, a sub communicator 130, a multimedia provider, 140, a camera 150, a global positioning system (GPS) 155, an inputter/outputter 160, a sensor 170, a storage 175, and a power supply 180.

The sub communicator 130 includes at least one of a wireless local area network (LAN) communicator 131 and a short distance communicator 132, and the multimedia provider 140 includes at least one of an audio player 141, a video player 143, and a broadcasting communicator 141.

The camera 150 includes at least one of a first camera 151 and a second camera 152, and an inputter/outputter 160 includes at least one of a button 161, the microphone 162, a speaker 163, a vibration motor 164, the connector 165, the inputter 166, and a keypad 167, and the sensor 170 includes the light sensor 171, the proximity sensor 172, and a gyro sensor 173.

The controller 110 may include a processor 111, a random access memory (ROM) 112 where a control program for controlling the portable apparatus 100 is stored therein, and a random access memory (RAM) 113, which stores a signal or data input from outside of the portable apparatus 100, or is used as a storage area regarding various operations performed by the portable apparatus 100.

The controller 110 performs a function to control overall operations of the portable apparatus 100 and signal flow between the elements 120-195 of the portable apparatus 100, and process data. The controller 110, by using the power supply 180, controls power supplied to the elements 120-195. Further, when a user input or a preset condition is satisfied, the controller 110 may execute an operation system (OS) or various applications stored in the storage 175.

The processor 111 may include a graphic processing unit (GPU, not illustrated) which is used for processing of graphics executed on the OS in various applications. The processor 111 may be realized in a core (not illustrated) and a GPU provided on a system on chip (SoC). The processor 111 may include a single core, a dual core, a triple core, a quad core, or a multiple core thereof. In addition, the processor 111, the ROM 112, and the RAM 113 may be interconnected by using an internal bus. For example, the processor 111 may be a central processing unit (CPU) which executes software programs stored in a storage, e.g., a memory.

The controller 110 may control the mobile communicator 120, the sub communicator 130, the multimedia provider 140, the camera 150, the GPS 155, the inputter/outputter 160, the sensor 170, the storage 175, the power supply 180, the touch screen 190, and the touch screen controller 195.

The controller 110 according to an exemplary embodiment may control to detect a touch from a shortcut icon which corresponds to a timeline application displayed on a home screen of a touch screen, and display a screen of the timeline application. The screen of the timeline application may include a timeline area and an event area. In the timeline area, a timeline including an event time is displayed in an interval corresponding to a time gap between a present time and the event time, and in the event area, event information corresponding to the event time is displayed.

The controller 110 may control to display the present time on the timeline area together with the timeline.

The controller 110 may control to display the event time with the present time as a starting position of the timeline.

The controller 110 may display additional information adjacent to the event time, wherein the additional information may include, for example, weather information.

The controller 110 may control to display the timeline area on at least one of up, down, left, and right sides of the event area according to a direction of the portable apparatus.

The controller 110, in response to event information being selected at the event area, may control to change a present position of the event time displayed on the timeline which corresponds to the selected event information.

The controller 110, in response to the event time being selected at the timeline area, may control to change a present position of the event information displayed on the event area to correspond to the selected event time.

The controller 110, in response to the changed present position of the event information, may control to display on the event area only the event information and next event information which corresponds to event time set as subsequent event time after the corresponding event time of the event information.

The controller 110 may further include a call screen area on the application screen, wherein the event may include an outgoing call, an incoming call, or an missed call.

The controller 110 may control to display the timeline area on a right side of the event area.

The controller 110, in response to a first touch gesture being detected from event information of the event area, may expand the timeline area corresponding to the event information at which the first touch gesture is detected, wherein the first touch gesture may include a tab or a double tab.

The controller 110, in response to a second touch gesture being detected from event information of the event area, controls to delete the event information, wherein the second touch gesture may include a flick or a swipe.

The controller 110 may control so that the timeline area may display missed calls in the past and the number of missed calls with respect to the present time.

In an exemplary embodiment, the term “controller” includes the processor 111, the ROM 112, and RAM 113.

The mobile communicator 120, in accordance with control by the controller 110, may be connected to an external apparatus by using at one or least two antennas or mobile communication. The mobile communicator 120, to/from an external apparatus including, for example, a cell phone, a smartphone, a tablet PC, or other portable apparatuses connectable to the portable apparatus 100, transceives a wireless signal for audio communication, video communication, short messaging service (SMS), multimedia messaging service (MMS), and data communication.

The sub communicator 130 may include at least one of the wireless LAN 131 and the short-distance communicator 132. For example, the sub communicator may include one of the wireless LAN 131 or the short-distance communicator 132, or both of the wireless LAN 131 and the short-distance communicator 132.

The wireless LAN 131, according to control of the controller 110, may be wirelessly connected to an access point (AP) at a place where the AP is installed. The wireless LAN 131 may support IEEE 802.11x of proposed by Institute of Electrical and Electronics Engineers (IEEE). Further, the short-distance communicator 132, according to control by the controller 110, may wirelessly communicate without the AP between the portable apparatus 100 and an external apparatus. The short-distance communication may include Bluetooth, Bluetooth low energy, infrared data association (IrDA), Wi-Fi, ultra wideband (UWB), and near field communication (NFC), or the like.

Depending on functionality, the portable apparatus 100 may include at least one of the mobile communicator 120, the wireless LAN 131, and the short-distance communicator 132. For example, the portable apparatus 100 may include one of the mobile communicator 120, the wireless LAN 131, and the short-distance communicator 132, or the combination of the mobile communicator 120, the wireless LAN 131, and the short-distance communicator 132.

In an exemplary embodiment, the term “a communicator” includes the mobile communicator 120 and the sub communicator 130.

The multimedia provider 140 may include the audio player 141, the video player 142, or the broadcasting communicator 143. The audio player 141, according to control by the controller 110, may play audio sources which are pre-stored in the storage 175 of the portable apparatus 100 or received from outside (for example, an audio file having a filename extension of mp3, wma, ogg, or way) using a codec.

According to an exemplary embodiment, the audio player 141, according to control of the controller 110, may play auditory feedback (for example, an output of an audio source stored in the storage 175) which corresponds to movement of event information at the event area or movement of event time at the timeline area through an audio codec. According to another exemplary embodiment, the audio player 141, according to control of the controller 110, may play auditory feedback (such as, the output of the audio source stored in the storage 175) which corresponds to extension of additional time area of event information at the event area or deletion of event information through the audio codec.

The video player 142, according to control of the controller 110, may play digital video source which is pre-stored in the storage 175 of the portable apparatus 100 or received from outside (for example, a file having a filename extension of mpeg, mpg, mp4, avi, mov, or mkv) using a video codec. Accordingly, applications installable in the portable apparatus 100 may play an audio source or a video file using the audio codec or the video codec.

According to an exemplary embodiment, the audio player 141 may play a visual feedback (for example, an output of a video source stored in the storage 175) which corresponds to movement of event information at the event area or movement of event time at the timeline area through the video codec. According to another exemplary embodiment, the audio player 141, in accordance with control by the controller 110, may play visual feedback (for example, the output of the video source stored in the storage 175) which corresponds to extension of additional time area of event information at the event area or deletion of event information through the video codec.

Those skilled in the art would easily understand that various types of video and audio codecs well known in the art may be used in exemplary embodiments.

The broadcasting communicator 143, according to control by the controller 110, may receive a broadcasting signal (for example, a TV broadcasting signal, a radio broadcasting signal, or a data broadcasting signal) transmitted from a broadcasting station through a broadcasting communication antenna and additional broadcasting information (for example, electric program guide (EPS) or electric service guide (ESG)). Further, the controller 110 may play the received broadcasting signal and additional broadcasting information using, for example, a touch screen, a video codec, and an audio codec.

In an exemplary embodiment, the multimedia provider 140, in response to functions or structure of the portable apparatus 100, may include the audio player 142 and the video player 143, excluding the broadcasting communicator 143. In addition, in an exemplary embodiment, the audio player 142 or the video player 143 of the multimedia provider 140 may be included in the controller 110.

In the exemplary embodiment, the term “audio codec” may include one or at least two audio codecs. In the exemplary embodiment, the term “video codec unit” may include one or at least two video codecs.

The camera 150, according to control of the controller 110, may include at least one of the first camera 151 on the front side 100a which photographs a still image or a video and the second camera 152 on the rear side 100c. The camera 150 may include one or both of the first camera 151 and the second 152. In addition, the first camera 151 or the second camera 152 may include subsidiary light source (for example, a flash 153) which provides light required for photographing.

The first camera 151 on the front side, according to control of the controller 110, by using an additional camera (for example, a third camera, not illustrated) which is located adjacent thereto (for example, within a distance of about 80 mm or less from the first camera 151), may photograph a three-dimensional still image or a three-dimensional video. Further, the second camera 152 on the rear side, according to control of the controller 110, by using an additional camera (for example, a fourth camera, not illustrated) which is located adjacent thereto (for example, within a distance of about 80 mm or less from the second camera 152), may photograph a three-dimensional still image or a three-dimensional video. In addition, the cameras 151 and 152, using a separate adapter and a lens, may perform wide angle photographing, telescopic photographing, and close-up photographing.

The GPS 155 receives information (for example, location information and/or time information) on a regular basis from a plurality of GPS satellites on an orbit of the Earth. The portable apparatus 100, using information received from the plurality of GPS satellites, may know a location, a moving speed, or moving time of the portable apparatus 100.

The inputter/outputter 160 may include at least one or two buttons 161, the microphone 162, the speaker 163, the vibration motor 164, the connector 165, the inputter 166, and the keypad 167.

Referring to FIGS. 1-2, the button 161 may include the home button 161a, the menu button 161b, and the back button 161c located on the bottom of the front side 100a, and the power/lock button 161d on the upper side 100b, and at least one volume button 161e. In an alternative embodiment, the portable apparatus 100 may include only the home button 161a on the front side 100a. The buttons 161a-161c of the portable apparatus 100 may be realized not only as a physical button but also a touch button in a bezel on the front side 100a, which surrounds the touch screen 190. In addition, the buttons 161a-161c of the portable apparatus 100 may be displayed on the touch screen 190 as a text, an image, or an icon.

The microphone 162, according to control of the controller 110, receives a voice or a sound from outside and generates an electric signal. The electric signal generated in the microphone 162 may be converted in the audio codec and stored in the storage 175, or output through the speaker 163. One or at least two microphones 162 may be located on the front side 100a, the upper side 100b, and the rear side 100c of the portable apparatus 100. Further, in an exemplary embodiment, only on the upper side 100b of the portable apparatus 100, one or at least two of the microphone 162 may be located.

The speaker 163, according to control of the controller 110, may output to outside the portable apparatus 100 a sound corresponding to various signals (for example, a wireless signal, a broadcasting signal, an audio source, a video file, or photographing, etc.) of the mobile communicator 120, the sub communicator 130, the multimedia provider 140, or the camera 150, using the audio codec.

The speaker 163 may output a sound (for example, a touch sound corresponding to telephone number input, or a sound of pressing a photographing button) corresponding to functions performed by the portable apparatus 100. One or a plurality of speakers 163 may be located on the front side 100a, the upper side 100b, or the rear side 100b of the portable apparatus 100. Referring to FIGS. 1 and 2, the speaker 163a is located on the lateral side of the portable apparatus 100. Although not shown in the drawings, a plurality of speakers may be located on each lateral side of the portable apparatus 100 such that a user may have a sound output effect which is different from when the speaker is located only one side of the portable terminal 100, e.g., the front side 100a or the rear side 100c. Further, in an alternative embodiment, a plurality of speakers may be located on the front side 100a of the portable apparatus 100.

In an exemplary embodiment, on the front side 100a and the rear side 100c, each of the speakers of the portable apparatus 100 may be located. Further, one speaker 163a may be located on the front side 100a of the portable apparatus 100, and a plurality of speakers may be located on the rear side 100c.

According to an exemplary embodiment, the audio player 141, in response to moving of event information at the event area or moving of event time at the timeline area in accordance with control of the controller 110, may output auditory feedback. According to another exemplary embodiment, the audio player 141, in accordance with control of the controller 110, may output auditory feedback in response to extension of additional time area of event information or deletion of event information at the event area.

The vibration motor 164, in accordance with control of the controller 110, may convert an electric signal to a mechanical vibration. The vibration motor 164 may include, for example, a linear vibration motor, a bar type vibration motor, a coin type vibration motor, or a piezoelectric element vibration motor. For example, in response to a voice call request being received from another portable apparatus, the vibration motor 164 of the portable apparatus 100 which is in a vibration mode operates in accordance with control of the controller 110. One or at least two vibration motors 164 may be provided to the portable apparatus 100. Further, the vibration motor 164 may vibrate an entire part of the portable apparatus 100 or vibrate a part of the portable apparatus 100.

According to an exemplary embodiment, the audio player 141, in accordance with control of the controller 110, may output tactile feedback in response to moving of event information at the event area or moving of event time at the event area. According to another exemplary embodiment, the audio player 141, in accordance with control of the controller 110, may output tactile feedback in response to extension of additional time area of event information at the event area or deletion of event information. Further, the vibration motor 164, based on a control command of the controller 110, may provide various tactile feedback (for example, having various strength of vibration or vibration duration) which is pre-stored or received from an external apparatus.

The connector 165 may be used as an interface to connect the portable apparatus 100 with an external apparatus, or connect the portable apparatus 100 and a power source.

In accordance with control of the controller 110, the portable apparatus 100 may transmit, through a wire cable connected to the connector 165, data stored in the storage 175 to an external apparatus, or receive data from an external apparatus. The portable apparatus 100, through a wire cable connected to the connector 165, may receive power from power source or charge a battery thereof. In addition, the portable apparatus 100, through the connector 165, may be connected to an external accessory such as, for example, a keyboard dock.

The inputter 166 may touch or select an object, for example, a menu, a text, an image, a figure, or an icon displayed on the touch screen 190 of the portable apparatus 100. The inputter 166, for example, may include a capacitive touch screen, a resistive touch screen, or electromagnetic resonance (EMR) type touch screen, or input letters using a virtual keyboard.

The inputter 166, for example, may be a haptic pen which vibrates by an embedded vibration element, for example, an actuator or a vibration motor, using control information received from a stylus or a communicator of the portable apparatus 100. Further, by using sensing information detected from an embedded sensor, for example, an acceleration sensor, not illustrated, of the haptic pen 167 instead of control information received from the portable apparatus 100, a vibration element of the portable terminal 100 may vibrate.

When the inputter 166 is withdrawn from an insertion hole of the portable apparatus 100, the controller 110 may execute a set application and display an application screen on the touch screen 190.

Those skilled in the art would easily understand that an insertion hole of the portable apparatus 100 and a shape or a structure of the inputter 166 may be changed according to a function or a structure of the portable apparatus 100.

The keypad 167 may receive a key input from a user to control the portable apparatus 100. The keypad 167 may include, for example, a physical keypad formed on the front side 100a of the portable apparatus 100, a virtual keypad displayed on the touch screen 190, or a physical keypad wirelessly connectable to the portable apparatus 100. Those skilled in the art may easily understand that the physical keypad provided on the front side 100a of the portable apparatus 100 may be excluded according to the function or the structure of the portable apparatus 100.

The sensor 170 includes at least one sensor which detects a state of the portable apparatus 100. The sensor 170, for example, may include the light sensor 171 which detects light of a surrounding area, the proximity sensor 172 which detects whether a user approaches the portable apparatus 100, and the gyro sensor 173 which detects a direction of the portable apparatus 100 using rotational inertia thereof. Further, although not shown in the drawings, the sensor 170 may include an acceleration sensor which may detect tilt on at least one of three axes, for example, axis x, axis y, and axis z of the portable apparatus 100, a gravity sensor which detects a direction of gravity, or an altimeter which detects altitude by measuring pressure of air.

The sensor 170 may measure motion acceleration and/or gravity acceleration of the portable apparatus 100. When the portable apparatus 170 does not move, the sensor 170 may measure gravity acceleration only. For example, when the front side 100a of the portable apparatus 100 faces an upward direction, gravity acceleration may be in a positive (+) direction, and when the rear side 100c of the portable apparatus 100 faces the upward direction, gravity acceleration may be in a negative (−) direction.

At least one sensor included in the sensor 170 detects a state of the portable apparatus 100, generates a corresponding signal, and transmits the signal to a controller 110. Those skilled in the art may easily understand that a sensor included in the sensor 170 may be added or deleted according to the function of the portable apparatus 100.

The storage 175, according to control of the controller 110, may store input and/or output signal or data corresponding to operations of the mobile communicator 120, the sub communicator 130, the multimedia provider 140, the camera 150, the GPS 155, the inputter/outputter 160, the sensor 170, and the touch screen 190.

The storage 175 may store a graphical user interface (GUI) related to a control program to control the portable apparatus 100 or the controller 110, or related to an application provided by a manufacturer or downloaded from outside. Also, the storage 175 may store images to provide the GUI, user information, documents, database, or relevant data.

The storage 175 according to an exemplary embodiment may store a type of timeline applications (for example, alarm application, etc.).

The storage 175 may store a timeline, event time displayed on the timeline, and additional information (for example, weather) of the event time.

The storage 175 may store event information and an event list.

The storage 175 may store a call log corresponding to an event.

The storage 175 may store location information corresponding to a touch of a shortcut icon, a touch of event information, and a touch of event time, or hovering information corresponding to hovering. The storage 175 may also store location information of a touch gesture corresponding to successive motions of a touch.

The storage 175 may store set time corresponding to movement of event information to an original location. The storage 175 may store set time corresponding to return of the extended timeline area to a former timeline area.

The storage 175 may store visual feedback (for example, a video source, etc.), recognizable by a user, which is output to the touch screen 190 corresponding to movement of event information, auditory feedback (for example, a sound source, etc.), recognizable by a user, which is output by the speaker 163, and tactile feedback (for example, haptic pattern, etc.), recognizable by a user, which is output from the vibration motor 164.

The storage 175 may store feedback providing time (for example, about 500 msec).

In an exemplary embodiment, the term “storage” includes the storage 175, the ROM 112 within the controller 110, a memory card (not illustrated) (for example, a micro secure digital (SD) card and a memory stick) provided on the RAM 113 within the controller 110. The storage may include a non-volatile memory, a volatile memory, a hard disk drive (HDD), or a solid state drive (SSD).

The power supply 180, according to control of the controller 110, may provide power to one or at least two batteries located inside the portable apparatus 100. The one or at least two batteries may be located between the touch screen, located on the front side 100a, and the rear side 100c. The power supply 180, according to control of the controller 110, through a wire cable connected to the connector 165, may supply power input from an external power source to the internal elements 110-195 of the portable apparatus 100. In addition, the power supply 180, according to control of the controller 110, may supply power, through wireless charging (for example, an electromagnetic resonance method, an electromagnetic wave method, or a magnetic induction method), to the portable apparatus 100.

The touch screen 190 may provide a user with the GUI corresponding to various services (for example, a voice call, a video call, data transmission, receiving broadcasting, photographing, viewing a video, or execution of an application). The touch screen 190 transmits to the touch screen controller 195 an analog signal corresponding to a single touch or a multi touch input through the home screen 191 or the GUI. The touch screen 190 may receive a single touch or a multi touch through the body of a user (for example, a finger including thumb) or the inputter 166.

In an exemplary embodiment, a touch is not limited to contact between the touch screen 190 and the body of a user, or contact between the touch screen 190 and the inputter 166, and may include non-contact (for example, hovering in which a distance between the touch screen 190 and the body of a user, or a distance between the touch screen 190 and the inputter 166 is less than a predetermined distance, e.g., about 50 mm. Those skilled in the art may easily understand that the non-contact distance detectable in the touch screen 190 may be changed in accordance with the function or the structure of the portable apparatus 100.

The touch screen 190, for example, may be implemented in, for example, the resistive method, the capacitive method, the infrared method, or the acoustic wave method. Further, the touch screen 190 may be implemented in the electromagnetic resonance method.

The touch screen controller 195 may convert an analog signal corresponding to a single touch or a multi touch received from the touch screen 190 into a digital signal containing, for example, X and Y coordinates corresponding to a detected touch location, and transmit the signal to the controller. The controller 110, by using the digital signal received from the touch screen controller 195, may obtain X and Y coordinates corresponding to touch location on the touch screen 190.

The controller 110, by using a digital signal received from the touch screen controller 195, may control the touch screen 190. For example, the controller 110, in response to an input touch, may display the shortcut icon 191a selected from the touch screen 190 distinctively from other shortcut icons 191b-191h. The controller 110 may execute an application (for example, S Note application) corresponding to the selected shortcut icon 191a, in response to the input touch, and display an application screen on the touch screen 190.

The touch screen controller 195 may include one or a plurality of touch screen controllers 195. In response to the function or the structure of the portable apparatus 100, the touch screen controller 195 may be included in the controller 110.

As to the elements of the portable apparatus 100 as illustrated in FIG. 3, in response to the function of the portable apparatus 100, at least one element may be added or deleted. In addition, those skilled in the art may easily understand that location of the elements may change in response to the function or the structure of the portable apparatus 100.

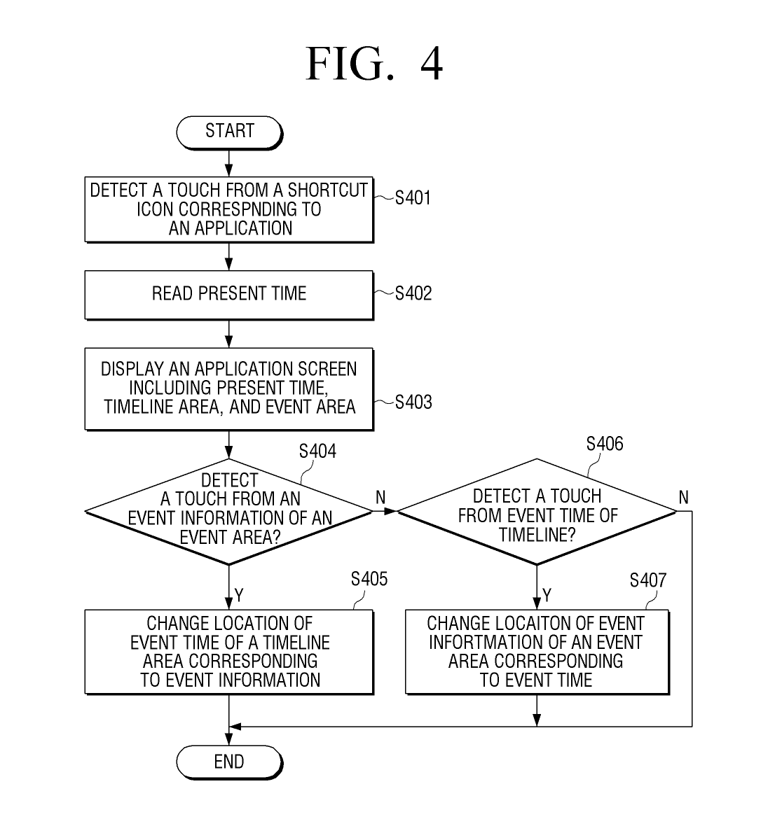

FIG. 4 is a flowchart illustrating a method for controlling brightness of a screen of a portable apparatus according to an exemplary embodiment.

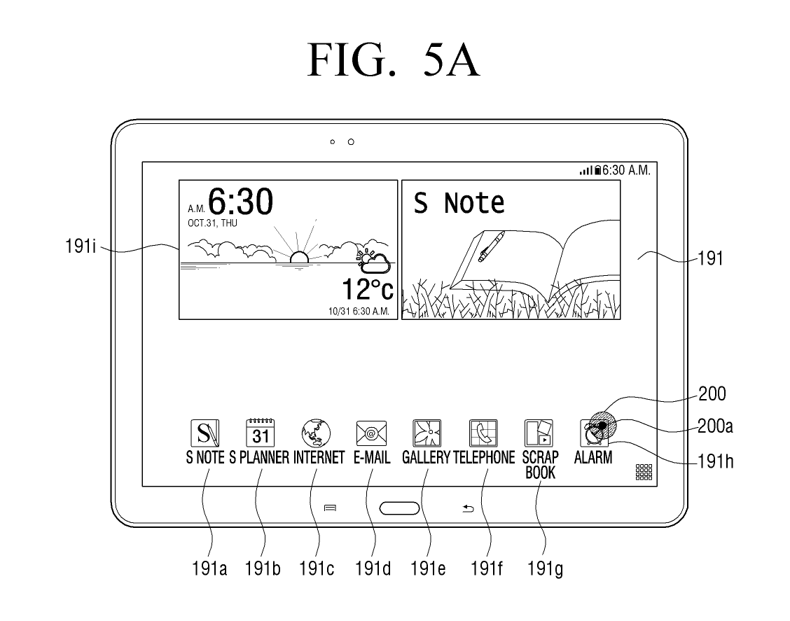

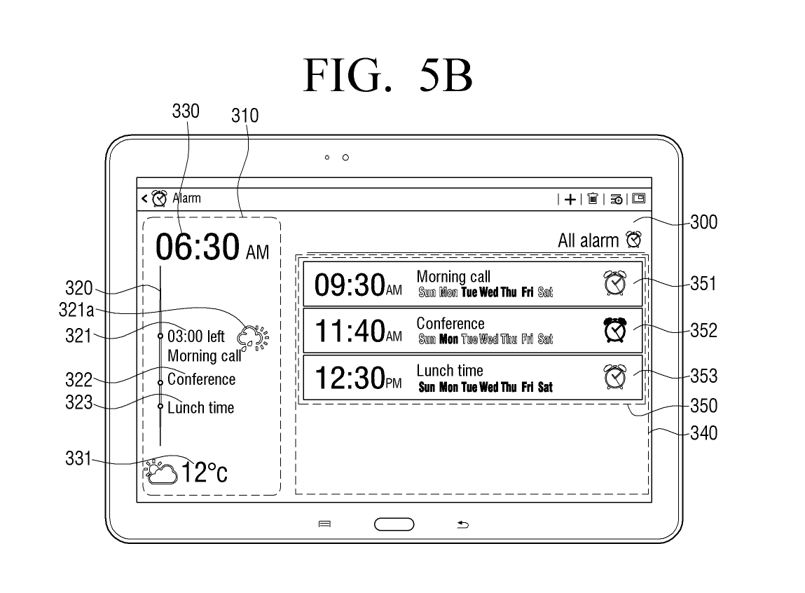

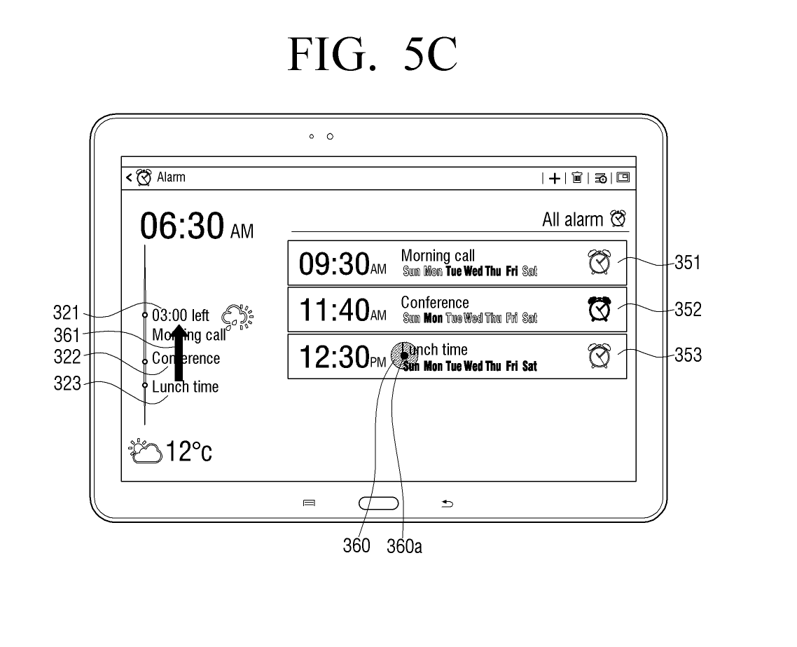

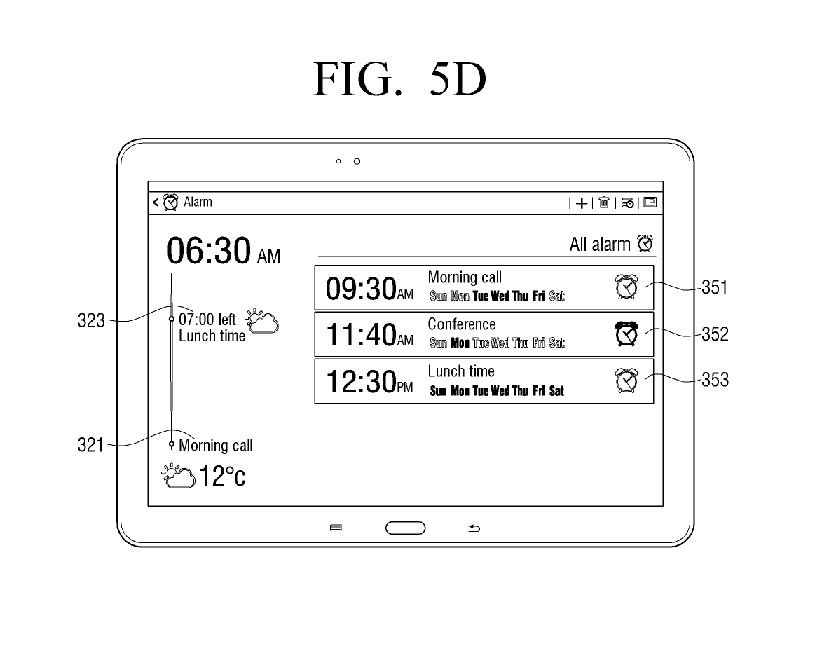

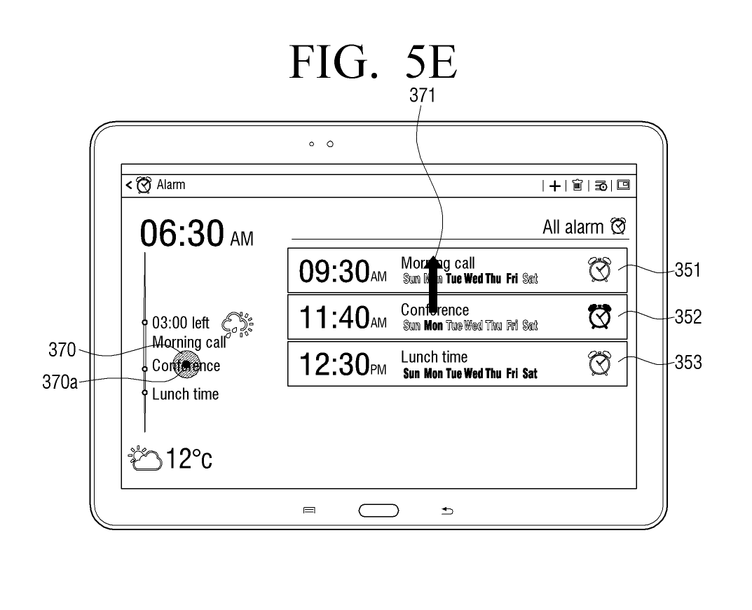

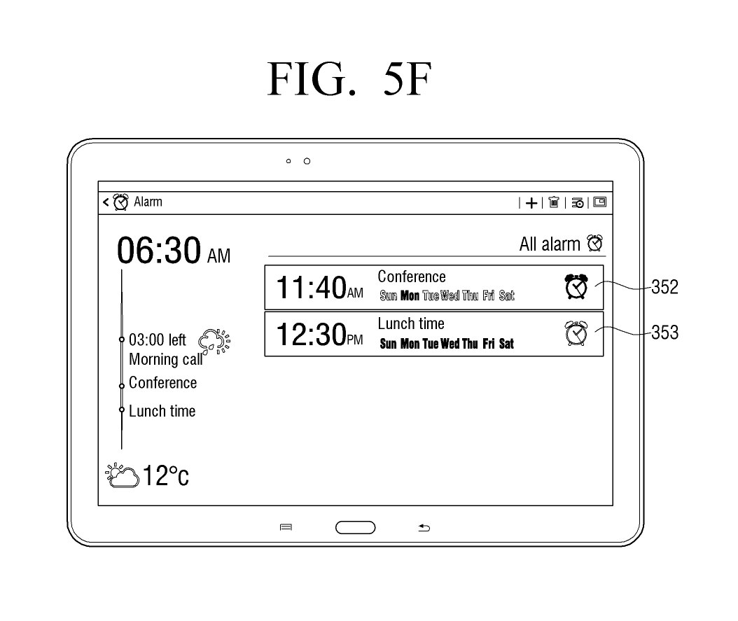

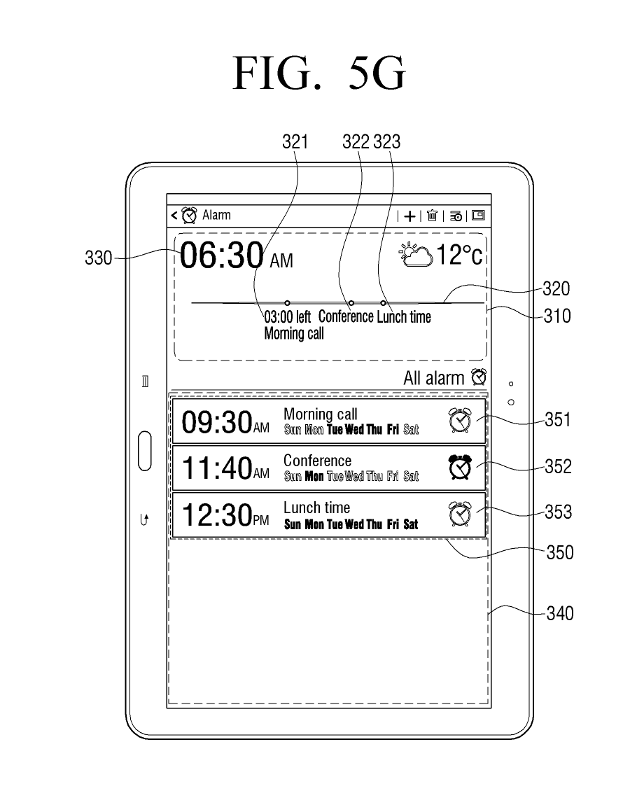

FIGS. 5A to 5G are views illustrating a method for displaying a screen of a portable apparatus according to an exemplary embodiment.

In S401 of FIG. 4, a touch is detected from a shortcut icon corresponding to an application.

Referring to FIG. 5A, the short icons 191a-191h corresponding to various applications and a widget 191i are displayed on the home screen 191 of the touch screen 190. A user performs the first touch 200 on the shortcut icon 191h of the touch screen 190.

The controller 110 may, by using the touch screen 190 and the touch screen controller 195, detect the first touch 200 from the shortcut icon 191h corresponding to a timeline application. The controller 110 may receive a first touch location 200a (for example, coordinates X1 and Y1) corresponding to the first touch 200 from the touch screen controller 195.

The timeline application may indicate an application which displays a timeline on a part of an application screen area. Also, the timeline application may indicate an application which displays a preset (or stored) event time on one side of the timeline. Further, the timeline application may indicate an application which displays event time disposed apart from each other in an interval corresponding to a time gap between a set (or stored) event time and the present time. Still further, the timeline application may indicate an application which includes additional information (for example, weather, etc.) displayed adjacent to the timeline. For example, the additional information may be displayed within a distance of about 50 mm or less from the timeline.

The timeline application may include, for example, an alarm application, a call application, a music application, a schedule application, and a photo application. For example, in case of the alarm application, alarm timings which are disposed apart from each other in an interval corresponding to a time gap between a set alarm and the present time may be displayed on a timeline. In case of the call application, call log information which is disposed apart from each other in an interval corresponding to a time gap between call log information and the present time may be displayed on a timeline. In case of the music application, a section corresponding to the present music play time from entire play time of music in a playlist may be displayed in a timeline. In case of the photo application, photos which are disposed apart from each other in an interval corresponding to a time gap between photo stored time and the present time may be displayed.

In an exemplary embodiment, a timeline application corresponding to the shortcut icon 191h, from which the first touch 200 is detected, may be the alarm application.

The controller 110 may store the first touch location information corresponding to the first touch location 200a in a storage 175. The stored first touch location information may include an identifier (ID) for history management, touch location, touch detection time, or touch information (for example, touch pressure, touch direction, touch duration, etc.). The first touch 200 may occur by one of fingers including thumb or the inputter 166.

Further, the controller 110, by using the touch screen 190 and the touch screen controller 195, may detect first hovering. The controller 110 may receive, from the touch screen controller 195, first hovering location corresponding to the first hovering.

The controller 110 may store first hovering location information corresponding to the first hovering location in the storage 175. The stored first hovering location information may include a hovering location, hovering detection time, or hovering information (for example, hovering height (h), hovering direction, hovering duration, etc.). The first hovering may occur by one of the fingers including thumb or the inputter 166.

In S402 of FIG. 4, the present time is read.

When the first touch 200 is detected, the controller 110 may read the present time. The controller 110 may read the present time calculated using GPS information or the present time calculated using a timer. The controller 110 may display the calculated present time on the home screen 191 or the status bar 192. Further, the controller 110 may also display the calculated present time on an application screen.

When the portable apparatus 100 is turned on, a base station of a mobile communication provider may receive GPS information received from a GPS satellite and transmit the information to the portable apparatus 100. The controller 110 of the portable apparatus 100 may calculate (or extract) the present time using the GPS information received through, for example, an antenna. The base station of a mobile communication provider may transmit regularly-received GPS information to the portable apparatus 100. The controller 110 may store the calculated (or extracted) present time in the storage 175 or display the stored present time on the touch screen 190.

The controller 110, through the GPS 155, may receive GPS information from the GPS satellite and calculate (or extract) the present time. The controller 110 may store the calculated (or extracted) present time in the storage or display the stored present time in the touch screen 190. Further, the controller 110 may not store the calculated (or extracted) present time in the storage 175, and display the present time on the touch screen 190.

When the portable apparatus 100 is located in a frequency shadow area (for example, an area in which breakaway of communication occurs), the controller 110, by using a timer embedded in the portable apparatus 100, may read and display the present time.

In S403 of FIG. 4, an application screen including the present time, the timeline area, and the event area is displayed.

Referring to FIGS. 5B and 5G, when the first touch 200 is detected in the shortcut icon 191h, the controller 110 displays an application screen 300 corresponding to the shortcut icon 191h. The application screen 300 may include the timeline area 310 and the event area 340. The controller 110 may display, as a background of the application screen 300, at least one of an image or a video corresponding to the present time 330 (for example, 6:30 a.m.) or the present weather 321a (for example, slightly cloudy). In addition, the controller 110 may change the background of the application screen 300 to correspond to at least one of the present time and the present weather. The application screen 300 may also include present temperature 331, which is 12° C.

FIG. 5B illustrates that the portable apparatus 100 is placed in a width (or landscape) direction, and FIG. 5G illustrates that the portable apparatus 100 is placed in a vertical (or portrait) direction.

The timeline area 310 may include a timeline 320 and set event time 321-323. A direction of the timeline 320 may change corresponding to a direction of the portable apparatus 100 (for example, a length or width direction). Each event time 321-323 may be displayed in one side of the timeline 320. An event time object (for example, an icon, a text, or an image) which corresponds to the each event time 321-323 may be displayed in the timeline 320. The event time may include a time gap (or remaining time) between the present time 330 and the corresponding event time, and an event title. In an exemplary embodiment, only a certain event time may display the time gap (or remaining time) between the present time 330 and the corresponding event time, while another event time may display an event title only, as shown in FIG. 5B.

Event time may include additional information 321a (for example, weather information). The weather information may include a weather information object (for example, an icon, a text, or an image) corresponding to weather forecast of set event time. The controller 110 may receive weather information through the communicator 120 or 130. The additional information 321a may be located facing opposite to the timeline 320.

The timeline area 310 may include the present time 330 and the additional information 331 (for example, temperature information) corresponding to the present time 330. The temperature information may include a temperature information object (for example, an icon, a text, or an image) corresponding to the present time 330 and the present temperature. The controller 110 may receive temperature information through the communicator 120 or 130.

The controller 110 may calculate a time gap between the present time 330 and the event time. The controller 110, by using the calculated time gap, may indicate the each event time 321-323 to be disposed apart from each other in a time gap corresponding to the calculated time gap.

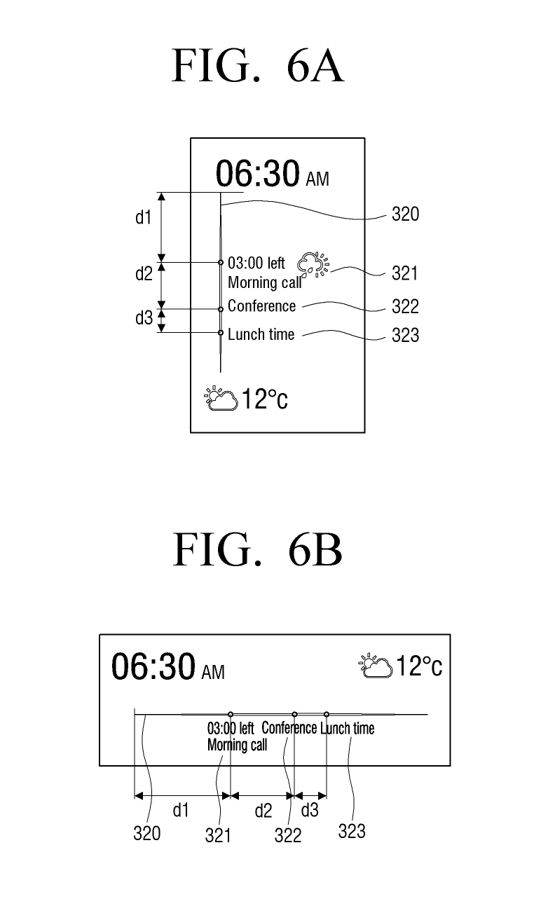

FIGS. 6A and 6B are views illustrating an event time interval of a timeline area according to an exemplary embodiment.

FIG. 6A illustrates a case in which the portable apparatus 100 is placed in a vertical direction. Each event time 321-323 may be displayed apart from each other at an interval d1, d2, d3, respectively, corresponding to a time gap with the present time 330, which is a start position of the timeline. Also, the each event time 321-323 may be displayed in a top-to-bottom direction with respect to the present time 330.

For example, when a time gap between the present time and the event time 321 is 1 hour, a time gap between the present time and the event time 322 is 2 hours (i.e., a time gap between two event time 321, 322 is 1 hour), and a time gap between the present time and the event time 323 is 3 hours (i.e., a time gap between two event time 322, 323 is 1 hour), the each event time 321-323 may be disposed apart from each other in the same interval of 1 hour (i.e., d1=d2=d3).

The bigger a time gap between the present time and the event time is, the wider an interval between the present time and the event time displayed in the timeline may be. For example, when a time gap between the present time and the event time 321 is 2 hours, an interval between the present time and the event time 321 may be wider than when a time gap between the present time and the event time 321 is 1 hour.

An interval of the each event time 321-323 may be displayed to be apart from each other in an interval corresponding to a time gap with the present time 330 as a starting position of the timeline in consideration of an entire length of the timeline 320. For example, when comparing the time line 320 with a length of 60 mm and the timeline 320 with a length of 40 mm, an interval between the present time and the event time 321 at the timeline 320 of 60 mm may be wider than an interval between the present time and the event time 321 at the timeline 320 of 40 mm.

A length of the timeline 320 may be changed by at least one of a size of the touch screen 190 of the portable apparatus 100 and a size of the application screen 300. For example, the length of the timeline 320 may be changed by one of a size of the touch screen 190 or a size of the application screen 300, or both the size of the touch screen 190 and the size of the application screen 300.

An interval between the each event time 321-323, in consideration of the number of event time, may be disposed apart from each other in an interval corresponding to a time gap with the present time 330 in a top-to-down direction from the present time 330 as a starting position of the timeline in consideration of the entire length of the timeline 320. For example, when comparing event time where the number of event is 2, and event time where the number of event is 4, an interval between the present time and the event time where the number of event is 2 may be wider than an interval between the present time and the event time where the number of event is 4. Further, for example, when comparing an interval between the event time where the number of event is 2 (for example, an interval with each event time is 2 hours) and an interval between the event time where the number of event is 4 (for example, an interval with each event time is 1 hour), in which an interval between the present time and the last event time is the same (for example, an interval between the present time and the last time is 4 hours), an interval between the present time and the first event time where the number of event is 2 (i.e., a time gap of 2 hours) may be wider than an interval between the present time and the first event where the number of event is 4 (i.e., a time gap of 1 hour).

Referring to FIG. 6B, a case in which the portable apparatus 100 is placed in a vertical (portrait) direction is illustrated. Each event time 321-323 may be disposed apart from each other in an interval corresponding to a time gap with the present time 330 as the starting position of the timeline. Also, the each event time 321-323 may be displayed in parallel with respect to the present time 330. An interval of the each event time 321-323 may be displayed to be apart from each other in an interval d1, d2, d3, respectively, corresponding to a time gap with the present time 330 as the starting position of the timeline in consideration of an entire length of the timeline 320. An interval between the each event time 321-323 may be displayed to be apart from each other in an interval corresponding to a time gap with the present time 330 in consideration of the entire length of the timeline 320, and the number of event time.

The interval between the each event time 321-323 in FIG. 6B is arranged substantially the same or similar to that of the exemplary embodiment of FIG. 6A, and thus will not be described.

Referring back to FIG. 5B, the event area 340 is located on one side of the timeline area 310. The event area 340 may include a list 350 of event information 351-353 corresponding to the event time 321-323. There may be event information corresponding to the number of event time. The event information 351-353 may be displayed in an order of event time 321-323 displayed in the timeline 320. Each event information 351-353 may include, for example, set event time, an event title, a set event day, and an event icon. In the each event information, a font size of the event time may be bigger than a font size of the event title or event day.

In response to a direction in which the portable apparatus 100 is placed detected through the sensor 170, the controller 110 may change locations of the timeline area 310 and the event area 340. The controller 110 may control, in response to the detected direction of the portable apparatus 100, to locate the timeline area 310 on one of, for example, an up, down, and right sides of the event area 340. For example, when the portable apparatus 100 is placed in a horizontal (or landscape) direction, the controller 110 may control so that the timeline area 310 is located in right side of the event area 340. When the portable apparatus 100 is in a vertical (or portrait) direction, the controller 110 may control the timeline area 310 to be located on, for example, an upper area of the event area 340.

Those skilled in the art may easily understand that the timeline area 310 may be located at one side of the event area 340 in response to a direction of the portable apparatus 100.

In S404 of FIG. 4, it is determined whether a touch is detected from event information of the event area.

Referring to FIG. 5C, a user performs a second touch 360 on the event information 353 of the event area 340.

The controller 110, using the touch screen 190 and the touch screen controller 195, may detect the second touch 360 from the event information 353 of the event area 340. The controller 110 may receive a second touch location (360a, for example, X2 and Y2) corresponding to the second touch 360 from the touch screen controller 195.

The controller 110 may store in the storage 175 second touch location information corresponding to the second touch location 360a. The stored second touch location information may include the ID for history management, touch location, touch detection time, or touch information (for example, touch pressure, touch direction, touch duration, etc.). The second touch 360 may occur by one of the fingers including thumb or the inputter 166.

In S404 of FIG. 4, the controller 110, by using the touch screen 190 and the touch screen controller 195, may detect second hovering and may receive second hovering location corresponding to the second hovering. The second hovering, the second hovering location, and second hovering location information are substantially the same or similar to the first hovering, the first hovering location, and the first hovering location information described above with respect to S401 in FIG. 4, and thus will not be further described.

When the second touch 360 is not detected in the event area 340, S406 is proceeded, which will be described later.

In S405 of FIG. 4, a location of the event time of the timeline area 310 corresponding to event information is changed.

Referring to FIGS. 5C and 5D, when the second touch 360 is detected from the event information 353, the controller 110 may move a location of the event time 323 corresponding to the event information 353 in the timeline area 310. A moving direction of the event time 323 may be an upward direction 361. The controller 110 may move, in response to moving of the event time 323, other event time 321, 322 in a downward direction. For example, as shown in FIG. 5D, the controller 110 may move and display only the event time 321 among the other event time 321, 322.

When moving of the event time 323 is completed, the event time 323 is displayed closer to the present time 330, and the event time 323 may display a time gap (or remaining time) with the present time 330 which was not displayed before moving.

The controller 110 may provide a user with a feedback in response to moving of the event time 323. The feedback, which may be at least one of a visual feedback, an auditory feedback, and a tactile feedback, may be provided to a user. The controller 110 may provide a user with one of the visual feedback, the auditory feedback, and the tactile feedback, or any combination of the visual feedback, the auditory feedback, and the tactile feedback.

In case of the visual feedback, a visual effect (for example, an animation effect such as fading), in response to moving of the event time 323, may be displayed distinctively from a plurality of objects displayed in the touch screen 190.

The auditory feedback may be a sound which, in response to moving of the event time 323, may be output from at least one of a plurality of speakers 163a. For example, the plurality of speakers 163a may include a first speaker and a second speaker and the auditory feedback may be output from one of the first or the second speaker or from both of the first and the second speakers.

The tactile feedback may be output from the vibration motor 164 as vibration, in response to moving of the event time 323. At least one feedback may be maintained from moving of the event time 323 to an original location of the event time 323. In performing environment setting of the portable apparatus 100, feedback (for example, at least one of the visual feedback, the auditory feedback, and the tactile feedback) corresponding to moving of the event time 323 may be selected and/or changed. Further, feedback providing time in which at least one feedback is provided to a user (for example, 500 msec) may be input and/or changed by a user.

When a preset time (for example, about 2 sec) is elapsed, the controller 110 may move the moved event time 323 to the original location thereof.

In S405 of FIG. 4, when the controller 110 moves the event time 323, a method for displaying a screen of the portable apparatus 100 may be terminated.

When referring back to S404 of FIG. 4, when the second touch is not detected from the event area, S406 is performed.

In S406 of FIG. 4, it is determined whether a touch is detected from the event time of the timeline area.

Referring to FIG. 5E, a user performs a third touch 370 on the event time 322 of the timeline area 310.

The controller 110, by using the touch screen 190 and the touch screen controller 195, may detect the third touch 370 of the event time 322 of the timeline area 310. The controller 110 may receive from the touch screen controller 195 third touch location (370a, for example, X3 and Y3) corresponding to the third touch 370.

The controller 110 may store third touch location information corresponding to the third touch location 370a in the storage 175. The stored third touch location information may include the ID for history management, touch location, touch detection time, or touch information (for example, touch pressure, touch direction, touch duration, etc.). The third touch 370 may occur by one of the fingers including the thumb or the inputter 166.

The controller 110, by using the touch screen 190 and the touch screen controller 195, may detect third hovering and may receive third hovering location corresponding to the third hovering. The third hovering, the third hovering location, and the third hovering location information of S406 in FIG. 4 are substantially the same or similar to the second hovering, the second hovering location, and the second hovering location information described above with respect to S404 of FIG. 4, and thus will not be further described.

In S407 of FIG. 4, location of event information of the event area corresponding to event time is changed.

Referring to FIGS. 5E and 5F, when the third touch 370 is detected from the event time 322, the controller 110 may move a location of the event information 352 corresponding to the event time 322 in the event area 340. A moving direction of the event information 352 may be an upward direction 371. The controller 110, in response to moving of the event information 352, may move other event information 351 and 353 in the upward direction. The controller 110, in response to moving of the event information 352, may display the other event information 351 and 353 as well. Further, the controller 110 may selectively not display other event information 351 and 353 in response to moving of the event information 352. For example, as shown in FIG. 5F, the controller 110 may move and display only the event information 353 among the other event information 351 and 353.

The controller 110 may provide a user with feedback in response to moving of the event information 352. The feedback to be provided may be at least one of the visual feedback, the auditory feedback, and the tactile feedback. The controller 110 may provide a user with one of the visual feedback, the auditory feedback, or the tactile feedback, or any combination of the visual feedback, the auditory feedback, and the tactile feedback.

The visual feedback may display the visual effect (for example, a separate image or an animation effect such as fading) corresponding to moving of the event information 352 in a distinctive manner over a plurality of objects displayed in the touch screen 190.

The auditory feedback may be a sound which, in response to moving of the event information 352, may be output from at least one of a plurality of speakers 163a. For example, the plurality of speakers 163a may include a first speaker and a second speaker and the auditory feedback may be output from one of the first or the second speaker or from both of the first and the second speakers.

The tactile feedback may be output from the vibration motor 164 as vibration, in response to the event information 352. At least one feedback may be maintained from moving of the event information 352 to the original location. In setting of the environment of the portable apparatus 100, feedback (for example, at least one of the visual feedback, the auditory feedback, and the tactile feedback) corresponding to moving of the event information 352 may be selected and/or changed. Further, feedback providing time (for example, 500 msec) in which at least one feedback is provided to a user may be input and/or changed by a user.

When a set time (for example, 2 sec) is elapsed, the controller 110 may move the moved event information 352 to the original location.

In S407 of FIG. 4, when the controller 110 moves the event information 352, a method for displaying a screen of a portable apparatus may be terminated.

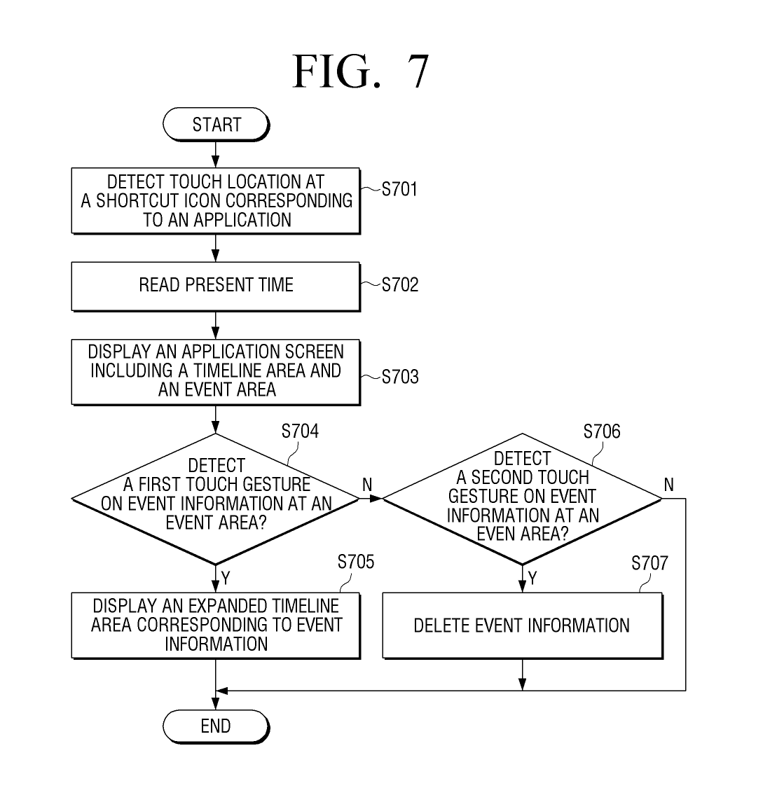

FIG. 7 is a flowchart illustrating a method for displaying a screen of a portable apparatus according to another exemplary embodiment.

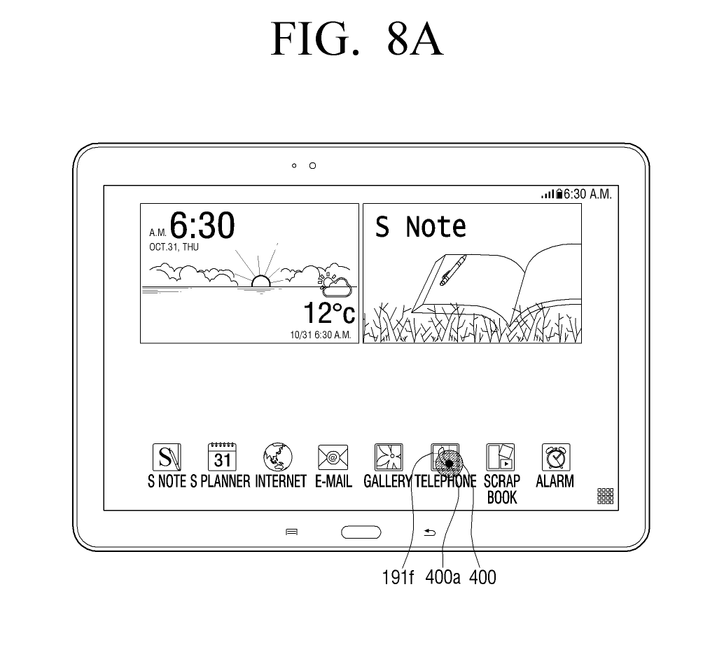

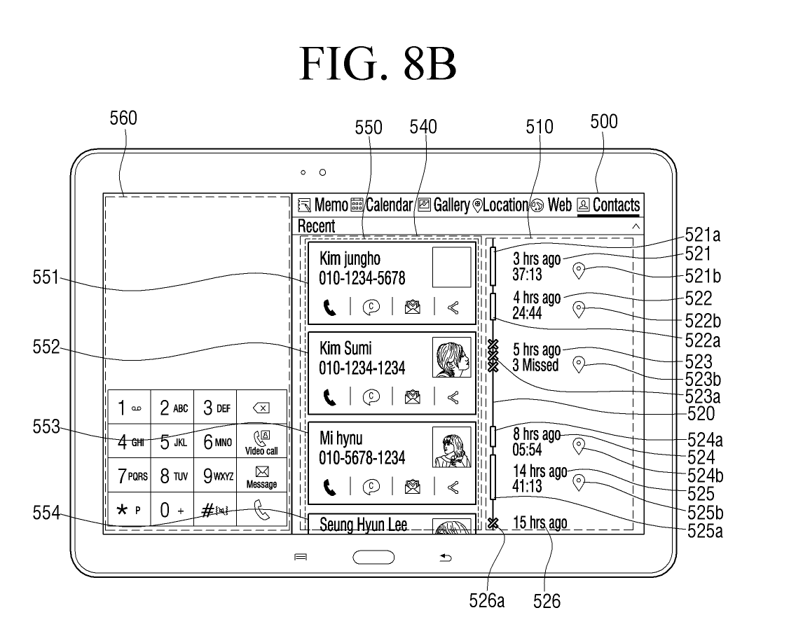

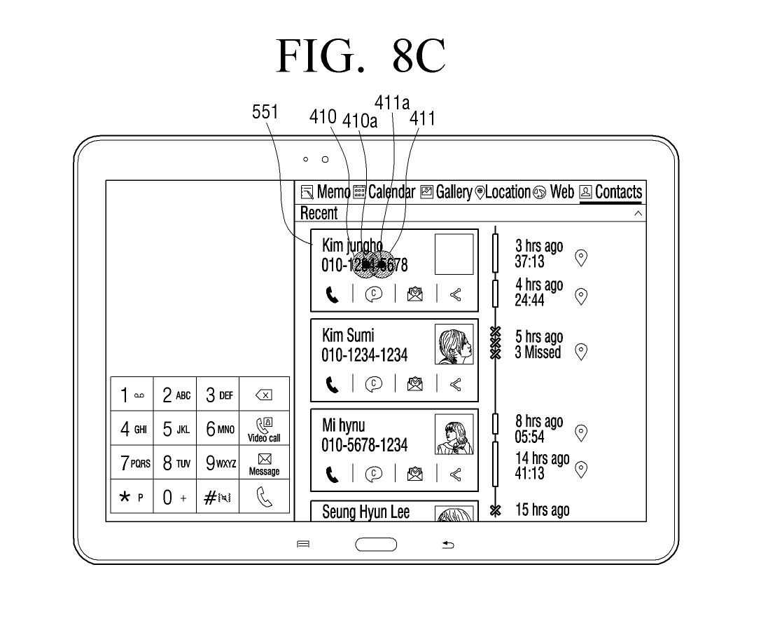

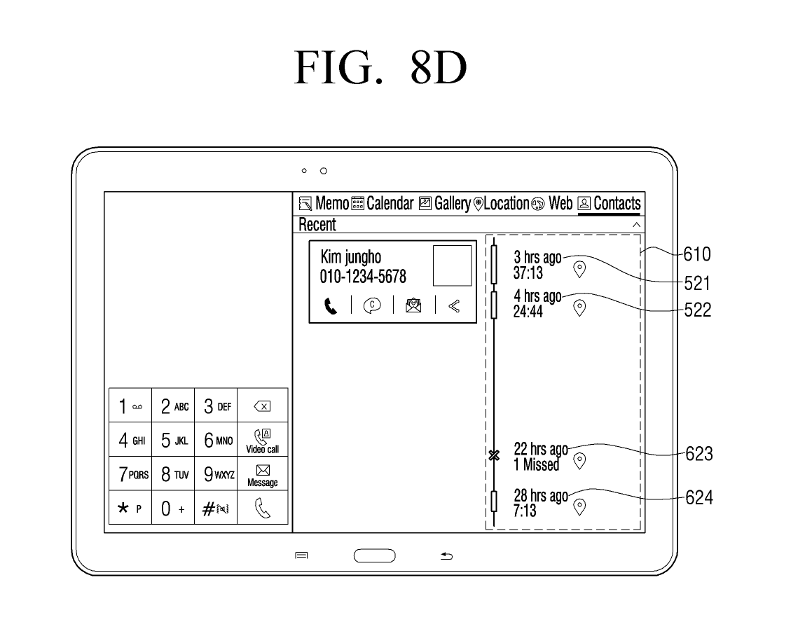

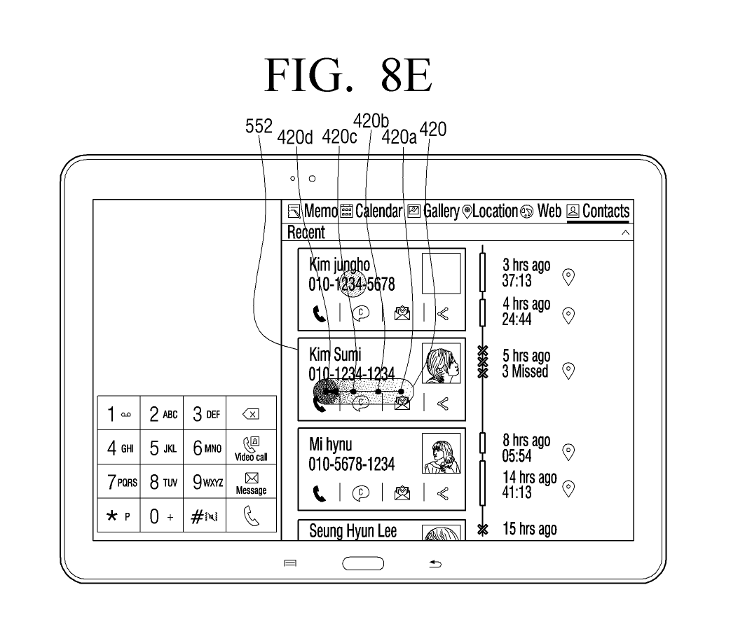

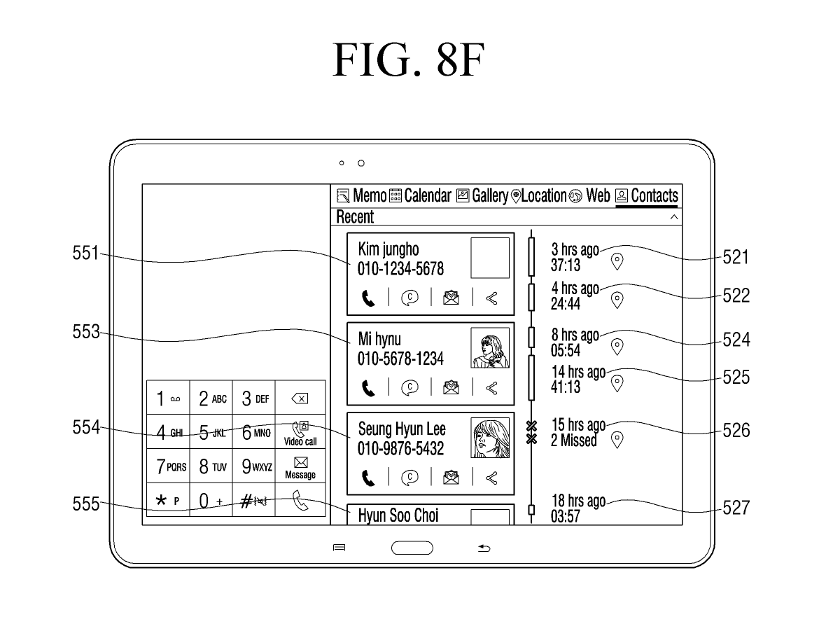

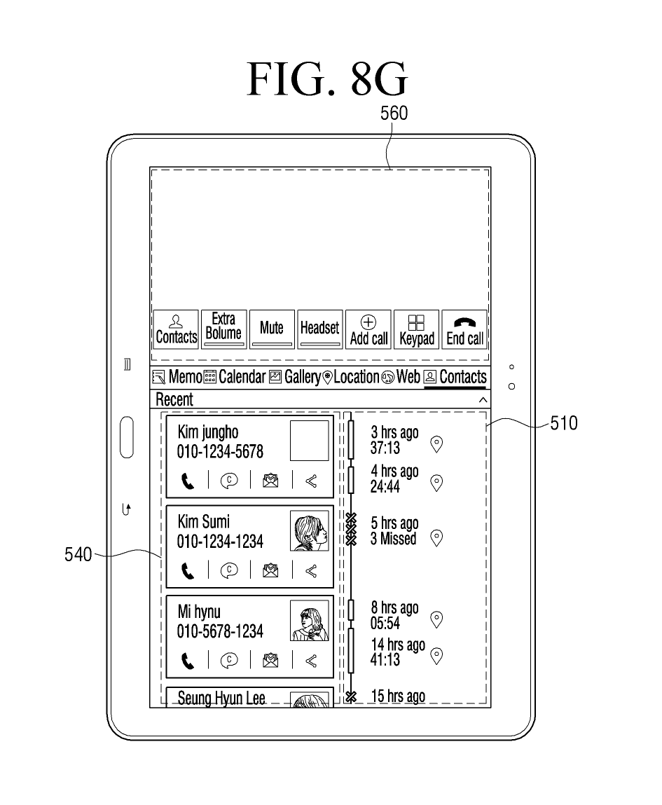

FIGS. 8A to 8G are views illustrating a method for displaying a screen of a portable apparatus according to another exemplary embodiment.

In S701 of FIG. 7, a touch at a shortcut icon corresponding to an application is detected.

Referring to FIG. 8A, a user performs a first touch 400 on the shortcut icon 191h of the touch screen 190. The controller 110, using the touch screen 190 and the touch screen controller 195, may detect the first touch 400 on the shortcut icon 191f corresponding to the timeline application. The controller 110, from the touch screen controller 195, may receive first touch location (400a, for example, X11 and Y11) corresponding to the first touch 200.

In another exemplary embodiment, a time application corresponding to the shortcut icon 191f where the first touch 400 is detected may be a call application.

The controller may store first touch location information corresponding to the 11th touch location 400a in the storage 175. The stored first touch location information may include the ID for history management, touch location, touch detection time, or touch information (for example, touch pressure, touch direction, touch duration, etc.). The first touch 400 may occur by one of the fingers including the thumb or the inputter 166.

In S701 of FIG. 7, the first hovering, the first hovering location, and the first hovering location information are substantially the same or similar to the first hovering, the first hovering location, and the first hovering location information described above with respect to S401 in FIG. 4, and thus will not be further described.

In S702 of FIG. 7, the present time is read.

When the first touch 400 is detected, the controller 110 may read the present time. The controller 110 may read the present time calculated by receiving GPS information or the present time calculated by using a timer. The controller 110 may display the calculated present time on the home screen 191 or the status bar 192. Further, the controller 110 may display the calculated present time on the application screen.

Operation at S702 of FIG. 7 is substantially the same or similar to operation at S402 of FIG. 4, and thus will not be described further.

In S703 of FIG. 7, an application including the timeline area and the event area is displayed.

Referring to FIGS. 8B and 8G, when the first touch 400 is detected on the shortcut icon 191f, the controller 110 displays the application screen 500 corresponding to the shortcut icon 191f. The application screen 500 may include a timeline area 510 and an event area 540. Further, the application screen 500 may include a call screen area 560. The call screen area 560 may be located on one side of one of the timeline area 510 and the event area 540.

FIG. 8B illustrates that the portable apparatus 100 is placed in a horizontal (or landscape) direction, and FIG. 8G illustrates that the portable apparatus 100 is in a vertical (or portrait) direction.

The timeline area 510 may include a timeline 520 and set event time 521-526. The timeline 520 may be changed (for example, a length or a width thereof) in response to a direction of the portable apparatus 100. Each event time 521-526 may be displayed on one side of the timeline 520. Event time object (for example, an icon, a text, or an image) corresponding to the each event time 521-526 may be displayed on the timeline 520. The event time 521, 522, 524, 525 may include a time gap between the present time, the event time, and call time. Starting of the call time corresponding to the event time 521, 522, 524, 525 may be displayed apart from each other in an interval corresponding to a time gap with the present time in the timeline 520. Further, the call time object (for example, an icon or an image, 521a, 522a, 524a, 525a) which corresponds to starting and ending of the call time may be displayed. Further, the event time 523, 526 may include a time gap (or elapsed time) between the present time, the event time, and the number of missed calls. The event time may include outgoing call time, incoming call time, or missed call time. Further, the event may include an outgoing call, an incoming call, or a missed call.

The event time 521-526 may include additional information (for example, location information, 521b, 522b, 523b, 524b, 525b, 526b). Location information may include a counterparty (for example, a receiver or a caller) corresponding to the event time, and brief information on a region of the counterparty (for example, city name, district name, etc.). The controller 110 may receive through communicator 120 or 130 information on the region of the counterparty. Additional information (521b, 522b, 523b, 524b, 525b, 526b) may be located facing opposite to the timeline 520.

The controller 110 may calculate a time gap between the present time and the event time. The controller 110, using the calculated time gap, may display the each event time 521-526 to be apart from each other in an interval corresponding to the time gap with the present time.

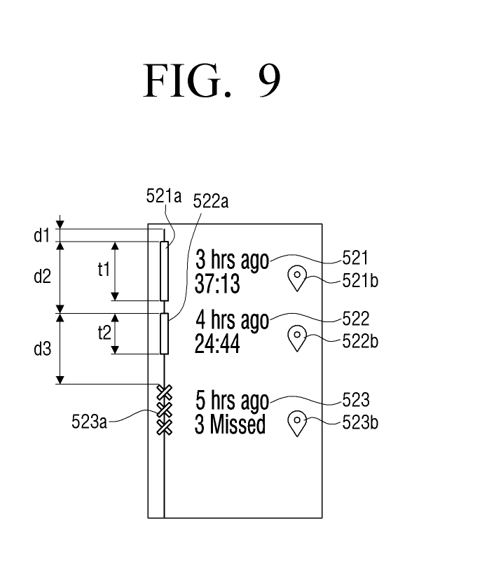

FIG. 9 is a view illustrating an event time interval of a timeline area according to another exemplary embodiment.

Referring to FIG. 9, the portable apparatus 100 is in a horizontal (or landscape) direction. Each event time 521-523 may be displayed to be apart from each other in intervals d1, d2, d3, respectively, corresponding to a time gap with the present time as the starting position on the timeline 520.

When the time gap between the present time and the event time 521 is 3 hours, time gap between the present time and the event time 522 is 4 hours (i.e., time gap between two event time 521, 522 is 1 hour), and time gap between the present time and the event time 523 is 5 hours (i.e., time gap between two event time 522, 523 is 1 hour), each event time 521-523 may be displayed to be apart from each other in the same interval (d2=d3). The interval d1 between the present time and the event time 521 may be narrower than the interval between the event time 521-523 in consideration of a length of the timeline 520.

In response to call time, a length of call time object 521a, 522b may be changed. For example, the call time object 521a for a call time t1 of 37 minutes and 13 seconds is longer than the call time object 522b for a call time t2 of 24 minutes and 44 seconds. The call time object 523a corresponding to a missed call may display an icon (for example, X) corresponding to the missed call on the timeline 520 in response to the number of missed calls.

The wider the time gap between the present time and the event time is, an interval between the present time and the event time displayed in the timeline may be wider. For example, an interval when the time gap between the present time and the event time 521 is 2 hours may be wider than an interval when the time gap between the present time and the event time 521 is 1 hour.

Each interval of the event time 521-526 may be displayed to be apart from each other in an interval corresponding to a time gap with the present time in consideration of the entire length of the timeline 320. For example, when comparing the timeline 520 whose length is 60 mm with the timeline 520 whose length is 40 mm, an interval from the present time to the event time 521 in the timeline of length of 60 mm may be wider than an interval from the present time to the event time 521 in the timeline of length of 40 mm.

A length of the timeline 520 may be changed by at least one of a size of the touch screen 190 of the portable apparatus 100 and a size of the application screen 500. For example, a length of the timeline 520 may be changed by one of the size of the touch screen 190 and the size of the application screen 500, or both the size of the touch screen 190 and the size of the application screen 500.

The each event time 521-526 may be displayed to be apart from each other in an interval corresponding to time gap with the present time, which is the starting point of the timeline, in consideration of the number of the event time. For example, when comparing the event time where the number of event is 2 and the event time where the number of event is 4, an interval between the event time and the present time may be wider when the number of event is 4 than when the number of event is 2.

Referring to FIG. 8G, the portable apparatus 100 is in a vertical (portrait) direction. The application screen 500 may include the call screen area 560 located on the timeline area 510 and the event area 540. Other parts of FIG. 8G are substantially the same or similar to FIG. 8B, and thus a redundant description thereof will be omitted.

The event area 540 is located on one side of the timeline area 510. The event area 540 may include a list 550 of event information (for example, call log information, 551-554) which corresponds to the event time 521-526. There may be event information corresponding to a counterparty (for example, a receiver or a caller). The number of event information 551-554 may be less than the event time 521-526. Further, there may be the event time 521-526 of which number is the same as the number of event information.

The event information 551-554 may be displayed in the order of the event time 521-526 displayed in the timeline 520. The event information may include a name or a telephone number of a counterparty (for example, a receiver or a caller). The event information 551-554 may include a photo of the counterparty. Further, the event information 551-554 may include a shortcut icon corresponding to a call, chatting, a mail, or content sharing.

In response to a direction of the portable apparatus 100 detected through the sensor 170, a location of the call screen area 560 may be changed. The controller 110, in response to a direction of the portable apparatus 100, may control the call screen area 560 to be located in, for example, an up, down, left, or right side of the event area 540. For example, when the portable apparatus 100 is in a horizontal (or landscape) direction, the controller 110 may control to locate the call screen area 560 in, for example, the left side of the event area 540. When the portable apparatus 100 is in a vertical (portrait) direction, the controller 110 may control the call screen area 560 to be located on an upper side of the event area 540.

Those skilled in the art may easily understand that the timeline area 310 may be located on one side of the event area 340 in response to a direction of the portable apparatus 100.

In S704 of FIG. 7, it is determined whether a first touch gesture is detected from event information of the event area.

Referring to FIG. 8C, a user performs first touch gestures 410, 411 on the first information 551 of the event area 540. The first touch gestures 410, 411 may be, for example but is not limited thereto, double tapping. Further, the first touch gesture may include various other touch gestures, for example, tapping, rotating, pinching, and spreading.

The controller 110, by using the touch screen 190 and the touch screen controller 195, may detect the first touch gestures 410, 411 from the event information 551 of the event area 540. The controller 110, from the touch screen controller 195, may receive first gesture location (410a, for example, X12 and Y12, and 411a, for example, X13 and X14) corresponding to the first touch gestures 410 and 411.

The controller 110 may store first touch gesture location information corresponding to the first touch gesture locations 410a, 411a in the storage 175. The stored first touch gesture location information may include the ID for history management, touch location, touch gesture detection time, or touch gesture information (for example, touch gesture pressure, touch gesture direction, touch gesture duration, etc.). The first touch gestures 410,411 may occur by one of the fingers including thumb or the inputter 166.

When the first touch gestures 410, 411 are not detected from the event area 540, S706 is proceeded.

In S705 of FIG. 7, an expanded timeline area corresponding to event information is displayed.

Referring to FIGS. 8C and 8D, when the first touch gestures 410, 411 are detected from the event 551, the controller 110 may display an expanded timeline area 610 corresponding to the event information 551. The controller 110, in the expanded timeline area 610, may add and display only event time corresponding to the selected event information 551. For example, the controller 110 may display event time 623, 624 which is not illustrated in the timeline area 510, in the expanded timeline area 610. The controller 110 may display the event time 623, 624 which is not displayed in the timeline area 510 to be apart from each other on the timeline 520, to correspond to time gap with the present time.

The controller 110 may not display other event information 552-554 in response to display of the expanded timeline area 610.

The controller 110 may provide a user with feedback in response to display of the expanded timeline area 610. The provided feedback may include a visual feedback, an auditory feedback, and a tactile feedback. The controller 110 may provide a user with one of the visual feedback, the auditory feedback, and the tactile feedback, or any combination of the visual feedback, the auditory feedback, and the tactile feedback.

The visual feedback may display the visual effect (for example, a separate image or an animation effect such as fading) in response to display of the expanded timeline area 610, in a manner distinctive from a plurality of objects displayed in the touch screen 190.

The auditory feedback, which may include a sound in response to the display of the expanded timeline area 610, may be output in at least one of a plurality of speakers 163a. For example, the plurality of speakers 163a may include a first speaker and a second speaker and the auditory feedback may be output from one of the first or the second speaker or from both of the first and the second speakers.

The tactile feedback may be output from the vibration motor 164 as vibration in response to display of the expanded timeline area 610. At least one feedback may be maintained in response to the display of the expanded timeline area 610 until when the expanded timeline area 610 is not displayed. In performing environment setting of the portable apparatus 100, feedback (for example, at least one of the visual feedback, the auditory feedback, and the tactile feedback) corresponding to the display of the expanded timeline area 610 may be selected and/or changed. Further, feedback providing time in which at least one feedback is provided to a user (for example, 500 msec) may be input and/or changed by a user.

When set time (for example, 2 sec) is elapsed, the controller 110 may display or return the expanded timeline area 610 to the original timeline area 510 or event area 540.

In S705 of FIG. 7, when the controller 110 displays the expanded timeline area 610, a method for displaying a screen by the portable apparatus is terminated.

When referring back to S704 of FIG. 7, when the first touch gesture is not detected in the event area, S706 is proceeded.

In S706 of FIG. 7, it is determined whether a second touch gesture is detected from the event information of the event area.

Referring to FIG. 8E, a user performs a second touch gesture 420 (for example, consecutive moving of a touch from 420a to 420d) on the event information 552 of the event area 540. The second touch gesture 420 may be a flick or a swipe. Further, the second touch gesture 420 may include various other touch gestures, for example, rotating, pinching, or spreading.

The controller 110, using the touch screen 190 and the touch screen controller 195, may detect the second touch gesture 420 from the event information 552 of the event area 540. The controller 110 may receive second tough gesture location (for example, a plurality of X and Y coordinates corresponding to consecutive moving of a touch) which corresponds to the second touch gesture 420, from the touch screen controller 195.

The controller 110 may store second touch gesture location information corresponding to the second touch gesture location (e.g., 420a to 420d) in the storage 175. The stored second touch gesture location information may include the ID for history management, touch location, touch detection time, or touch information (for example, touch pressure, touch direction, touch duration, etc.). The second touch gesture 420 may occur by one of the fingers including thumb or the inputter 166.

In S707 of FIG. 7, corresponding event information is deleted.

Referring to FIG. 8F, when the second touch gesture 420 is detected from the event information 552, the controller 110 may delete the event information 552 from the event information list 550. Further, the controller 110 may delete the event time 523 corresponding to the event information 552 in the timeline area 510.

The controller 110, in response to deletion of the event information 552, may move other event information 553-555 in, for example, an upward direction. The controller 110, in response to moving other event information 553-555, may move the event time 524-527.

The controller 110 may provide a user with feedback to respond to deletion of the event information 552. The provided feedback may include one of the visual feedback, the auditory feedback, and the tactile feedback. The controller 110 may provide a user with one of the visual feedback, the auditory feedback, or the tactile feedback, or any combination of the visual feedback, the auditory feedback, and the tactile feedback.

In case of the visual feedback, the visual effect (for example, an animation effect such as fading), in response to deletion of the event information 552, may be displayed distinctively from a plurality of objects displayed on the touch screen 190.

The auditory feedback may include a sound which, in response to deletion of the event information 552, may be output from at least one of a plurality of speakers 163a. For example, the plurality of speakers 163a may include a first speaker and a second speaker and the auditory feedback may be output from one of the first or the second speaker or from both of the first and the second speakers.

The tactile feedback may be output from the vibration motor 164 as vibration in response to deletion of the event information 552. In performing environment setting of the portable apparatus 100, feedback (for example, at least one of the visual feedback, the auditory feedback, and the tactile feedback) corresponding to the deletion of the event information 552 may be selected and/or changed. Further, feedback providing time in which at least one feedback is provided to a user (for example, 500 msec) may be input and/or changed by a user.

In S405 of FIG. 4, when the controller 110 deletes the event information 552, a method for displaying a screen of the portable apparatus may be terminated.

The methods according to exemplary embodiments may be realized as a program command which is executable by various computer means and be stored in a computer-readable medium. The computer-readable medium may include a program command, data file, data structure solely or in combination. For example, the computer-readable medium, regardless of whether deletion or re-recording is available, may be recorded using optical or electromagnetic methods such as volatile or non-volatile storage such as a ROM, a RAM, a memory chip, a memory, a compact disc (CD), a digital versatile disc (DVD), a magnetic disc, or a magnetic tape, or stored in a machine (for example, computer-readable storage medium). A memory which may be included in a mobile terminal may be an example of a program including the exemplary embodiments or a storage medium readable by machine which may store a program. The program command stored in the above medium may be specially designed or configured for the exemplary embodiments. Furthermore, the computer-readable medium may include a computer storage medium and a communication medium. The computer storage medium include both volatile and nonvolatile and both detachable and non-detachable medium implemented by any method or technique for storing information such as computer-readable instructions, data structures, program modules or other data. The communication medium typically embody computer-readable instructions, data structures, program modules, other data of a modulated data signal such as a carrier wave, or other transmission mechanism, and they include any information transmission medium.

Accordingly, according to the exemplary embodiments, a portable apparatus which displays an application screen including a timeline area and an event area and a method for displaying a screen may be provided, wherein the timeline area includes a timeline for displaying event time.

According to the exemplary embodiments, a portable apparatus which displays an application screen including a timeline area which includes a timeline that displays event time disposed apart from each other in an interval corresponding to a time gap between a present time and an event time, and an event area, and a method for displaying a screen may be provided.

According to the exemplary embodiments, a portable apparatus which displays an application screen including a timeline area which includes a timeline that displays present time along with event time disposed apart from each other in an interval corresponding to a time gap between a present time and an event time, and an event area, and a method for displaying a screen may be provided.

According to the exemplary embodiments, a portable apparatus which displays an application screen including a timeline area which includes a timeline that displays event time, and an event area including event information corresponding to event time, and a method for displaying a screen may be provided.

According to the exemplary embodiments, when a touch is detected at event time of a timeline area, a portable apparatus which changes location of event information of an event area corresponding to the event time at which the touch is detected, and a method for displaying a screen may be provided.

According to the exemplary embodiments, when a touch is detected at event information of an event area, a portable apparatus which changes location of event time of a timeline corresponding to the event information at which the touch is detected, and a method for displaying a screen may be provided.

According to the exemplary embodiments, when a touch gesture is detected at event information of an event area, a portable apparatus which expands a timeline area corresponding to the event information at which the touch gesture is detected, and a method for displaying a screen may be provided.

According to the exemplary embodiments, when a touch gesture is detected at event information of an event area, a portable apparatus which deletes the event information at which the touch gesture is detected and a method for displaying a screen may be provided.

According to the aforementioned various exemplary embodiments, but not limited thereto, a portable apparatus which displays an application screen which includes a timeline area including a timeline which displays the event time disposed apart from each other in an interval corresponding to a time gap between a present time and a set event time, and an event area, and a method for displaying a screen may be provided.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. A method for displaying a screen of a portable apparatus, the method comprising:
detecting a touch on an icon corresponding to a timeline application displayed on a touch screen; and
displaying a screen of the timeline application including a timeline area in which a timeline including a plurality of event times is displayed and an event area in which a plurality of event information corresponding to the plurality of event times is displayed,
wherein the plurality of event times are disposed apart from one another at an interval corresponding to a time gap therebetween in the timeline.

2. The method as claimed in claim 1, wherein the timeline application comprises an alarm application, and
wherein the displaying comprises displaying a present time on the timeline area.

3. The method as claimed in claim 1, wherein the timeline displays a present time as a starting position of the timeline, and
the plurality of event times are disposed on the timeline according to a time gap from the present time.

4. The method as claimed in claim 1, wherein the displaying comprises displaying additional information including weather information corresponding to at least one of the plurality of event times.

5. The method as claimed in claim 1, further comprising:
detecting a direction in which the portable apparatus is positioned,
wherein the displaying comprises displaying the timeline area on at least one from among an upper side, a lower side, a left side, and a right side of the event area, according to the detected direction.

6. The method as claimed in claim 1, further comprising:
in response to selecting event information at the event area, changing a position of an event time, which is displayed on the timeline, corresponding to the selected event information.

7. The method as claimed in claim 1, further comprising:
in response to selecting an event time at the timeline area, changing a position of event information, which is displayed on the event area, corresponding to the selected event time.

8. The method as claimed in claim 8, further comprising:
based on the changed position of the event information corresponding to the selected event time, displaying on the event area the event information and next event information, the next event information corresponding to an event time subsequent to the selected event time in a temporal order.

9. The method as claimed in claim 1, wherein the timeline application comprises a call application,
wherein the application screen further comprises a call screen area, and
wherein the plurality of event information comprises at least one from among an outgoing call, an incoming call, and an missed call.

10. The method as claimed in claim 9, wherein the timeline area is displayed on at least one of a right side and a left side of the event area.

11. The method as claimed in claim 9, wherein, the displaying comprises displaying, at the timeline area, at least one from among a past call start time, a past call duration time, and a time gap between the past call start time and a present time.

12. The method as claimed in claim 9, further comprising:
in response to a first touch gesture detected from event information of the event area, expanding the timeline area which corresponds to the event information.

13. The method as claimed in claim 9, further comprising:
in response to a second touch gesture detected from event information of the event area, deleting the event information.

14. The method as claimed in claim 9, wherein the displaying comprises displaying, on the timeline area, at least missed call and the number of the at least one missed calls.

15. A portable apparatus, comprising:
a touch screen configured to display an icon corresponding to a timeline application; and
a controller configured to control the touch screen,
wherein the controller configured to, in response to a touch on the icon, control the touch screen to display a screen of the timeline application including a timeline area in which a timeline including a plurality of event times is displayed and an event area in which a plurality of event information corresponding to the plurality of event times is displayed,
wherein the plurality of event times are disposed apart from one another at an interval corresponding to a time gap therebetween in the timeline.

16. The apparatus as claimed in claim 15, further comprising:
a sensor configured to detect a direction in which the portable apparatus is positioned,
wherein the controller controls the touch screen to display the timeline area on at least one from among an upper side, a lower side, a left side, and a right side of the event area, according to the detected direction.

17. The apparatus as claimed in claim 15, wherein the controller, in response to selecting event information at the event area, controls to change a position of an event time, which is displayed on the timeline, corresponding to the selected event information, and update additional information which is displayed corresponding to the event time.

18. The apparatus as claimed in claim 15, wherein the controller, in response to selecting an event time at the timeline area, changes a position of event information, which is displayed on the event area, corresponding to the selected event time, and displays on the event area the event information and next event information, the next event information corresponding to an event time subsequent to the selected event time in a temporal order.

19. The apparatus as claimed in claim 15, wherein the application screen further comprises a call screen area, and
wherein the controller controls to display the timeline area on at least one of a right side and a left side of the event area.

20. The apparatus as claimed in claim 15, wherein the controller controls to display each of the plurality of event times, on the timeline, according to a time gap between the each of the plurality of event times and the present time which is a starting position of the timeline.
